(19) United States
(12) Patent Application Publication
(10) Pub. No.: US 2025/0184998 A1
(43) Pub. Date: Jun. 5, 2025

(54) SCHEDULING REQUEST TECHNIQUES IN WIRELESS COMMUNICATIONS

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/816,670

(22) Filed: Aug. 27, 2024

Related U.S. Application Data
(60) Provisional application No. 63/605,209, filed on Dec. 1, 2023.

(51) Int. Cl. H04W 72/1268; H04W 24/02; H04W 72/21

(52) U.S. Cl. CPC H04W 72/1268; H04W 24/02; H04W 72/21

(57) ABSTRACT

Methods, systems, and devices for wireless communications are described that provide for coordination between a user equipment (UE) and a network entity that supports uplink prescheduling communications to the UE, where the UE may skip scheduling request (SR) transmission(s) based on an expected uplink prescheduling communication. A network entity may provide uplink prescheduling information to the UE with parameters for uplink prescheduling communications. The network may transmit the uplink prescheduling communications that provide uplink grants to the UE, without receiving a SR from the UE. In the event that a UE receives data in its uplink buffer, the UE may determine whether or not to transmit a SR based on the parameters of the uplink prescheduling information, a discontinuous reception activity/inactivity state, or both. The UE may further indicate one or more uplink prescheduling communications are to be skipped based on a traffic predication or expected uplink data flow.

### CROSS REFERENCE

The present application for patent claims the benefit of U.S. Provisional Patent Application No. 63/605,209 by YANG et al., entitled “SCHEDULING REQUEST TECHNIQUES IN WIRELESS COMMUNICATIONS,” filed Dec. 1, 2023, assigned to the assignee hereof, and expressly incorporated by reference herein.

### FIELD OF TECHNOLOGY

The following relates to wireless communications, including scheduling request techniques in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support scheduling request techniques in wireless communications. For example, the described techniques provide for coordination between a user equipment (UE) and a network entity that supports uplink prescheduling communications to the UE, where the UE may skip one or more scheduling request (SR) transmissions based on an expected uplink prescheduling communication. In some aspects, a UE may transmit a capability indication that the UE supports skipping of SR transmissions. In response to the capability indication, a network entity may provide uplink prescheduling information to the UE that indicates parameters for uplink prescheduling communications. In some aspects, the UE may request an adjustment to one or more parameters of the uplink prescheduling information, and in some cases the network entity and UE may negotiate one or more parameters. The network may transmit the uplink prescheduling communications that provide uplink grants to the UE, without receiving a SR from the UE, in accordance with the uplink prescheduling information. In some aspects, in the event that a UE receives data in its uplink buffer, the UE may determine whether or not to transmit a SR based on the parameters of the uplink prescheduling information. Additionally, or alternatively, a UE may transmit a medium access control (MAC) control element (CE) with an uplink communication that indicates the UE will skip one or more uplink transmissions that use uplink prescheduling, and the network entity may adjust one or more parameters provided in the uplink prescheduling information based on the indication in the MAC-CE.

A method for wireless communications by a user equipment (UE) is described. The method may include transmitting a capability indication that indicates that the UE supports skipping of scheduling request transmissions for one or more corresponding uplink transmissions, receiving uplink prescheduling information that indicates uplink prescheduling is to be provided to the UE and one or more parameters associated with the uplink prescheduling, and determining, when uplink data is present at the UE to be transmitted in a first uplink transmission, to skip a transmission of a first scheduling request to request uplink resources for the first uplink transmission, where the determination to skip the transmission of the first scheduling request is based on the one or more parameters associated with the uplink prescheduling.

A UE for wireless communications is described. The UE may include one or more memories storing processor executable code, and one or more processors coupled with the one or more memories. The one or more processors may individually or collectively operable to execute the code to cause the UE to transmit a capability indication that indicates that the UE supports skipping of scheduling request transmissions for one or more corresponding uplink transmissions, receive uplink prescheduling information that indicates uplink prescheduling is to be provided to the UE and one or more parameters associated with the uplink prescheduling, and determine, when uplink data is present at the UE to be transmitted in a first uplink transmission, to skip a transmission of a first scheduling request to request uplink resources for the first uplink transmission, where the determination to skip the transmission of the first scheduling request is based on the one or more parameters associated with the uplink prescheduling.

Another UE for wireless communications is described. The UE may include means for transmitting a capability indication that indicates that the UE supports skipping of scheduling request transmissions for one or more corresponding uplink transmissions, means for receiving uplink prescheduling information that indicates uplink prescheduling is to be provided to the UE and one or more parameters associated with the uplink prescheduling, and means for determining, when uplink data is present at the UE to be transmitted in a first uplink transmission, to skip a transmission of a first scheduling request to request uplink resources for the first uplink transmission, where the determination to skip the transmission of the first scheduling request is based on the one or more parameters associated with the uplink prescheduling.

A non-transitory computer-readable medium storing code for wireless communications is described. The code may include instructions executable by one or more processors to transmit a capability indication that indicates that the UE supports skipping of scheduling request transmissions for one or more corresponding uplink transmissions, receive uplink prescheduling information that indicates uplink prescheduling is to be provided to the UE and one or more parameters associated with the uplink prescheduling, and determine, when uplink data is present at the UE to be transmitted in a first uplink transmission, to skip a transmission of a first scheduling request to request uplink resources for the first uplink transmission, where the determination to skip the transmission of the first scheduling request is based on the one or more parameters associated with the uplink prescheduling.

Some examples of the method, UEs, and non-transitory computer-readable medium described herein may further include operations, features, means, or instructions for receiving a first uplink prescheduling transmission that provides a first uplink grant to the UE and transmitting the first uplink transmission using uplink resources provided in the first uplink grant.

Some examples of the method, UEs, and non-transitory computer-readable medium described herein may further include operations, features, means, or instructions for transmitting a request to adjust at least one of the one or more parameters associated with the uplink prescheduling. Some examples of the method, UEs, and non-transitory computer-readable medium described herein may further include operations, features, means, or instructions for receiving updated uplink prescheduling information based on the request. In some examples of the method, UEs, and non-transitory computer-readable medium described herein, the request may be transmitted subsequent to one or more uplink transmissions that use uplink resources indicated in one or more corresponding uplink prescheduling transmissions. In some examples of the method, UEs, and non-transitory computer-readable medium described herein, the request to adjust at least one of the one or more parameters associated with the uplink prescheduling may be based on one or more quality of service targets associated with uplink data that is to be transmitted from the UE.

In some examples of the method, UEs, and non-transitory computer-readable medium described herein, the one or more parameters associated with the uplink prescheduling include one or more of a type of uplink data to be transmitted, a trigger condition for initiating the uplink prescheduling, a time interval over which the uplink prescheduling will be provided, a periodicity of associated uplink transmissions, a duration of the uplink prescheduling, a transport block size of uplink grants to be provided by the uplink prescheduling, or any combinations thereof.

Some examples of the method, UEs, and non-transitory computer-readable medium described herein may further include operations, features, means, or instructions for receiving uplink data to be transmitted in an uplink buffer at the UE, and where the determining may be further based on one or more of a time interval between an arrival of the uplink data in the uplink buffer and a next uplink prescheduling transmission, a quality of service associated with the uplink data, a latency target associated with the uplink data, or any combinations thereof.

Some examples of the method, UEs, and non-transitory computer-readable medium described herein may further include operations, features, means, or instructions for maintaining a discontinuous transmission off state at the UE during a scheduling request occasion associated with the first scheduling request responsive to determining to skip the transmission of the first scheduling request.

Some examples of the method, UEs, and non-transitory computer-readable medium described herein may further include operations, features, means, or instructions for receiving, subsequent to the first uplink transmission, uplink data to be transmitted in a second uplink transmission from the UE and transmitting a second scheduling request to request uplink resources for the second uplink transmission based on a time interval to a next uplink prescheduling transmission being greater than a threshold value.

Some examples of the method, UEs, and non-transitory computer-readable medium described herein may further include operations, features, means, or instructions for transmitting an indication to start or stop skipping of scheduling request transmissions at the UE based on a periodicity of the uplink prescheduling, a transport block size associated with the uplink prescheduling, quality of service class identifier (QCI) of data to be transmitted from the UE, a discontinuous reception (DRX) configuration, an uplink traffic pattern at the UE, an application associated with the data to be transmitted from the UE, or any combinations thereof.

Some examples of the method, UEs, and non-transitory computer-readable medium described herein may further include operations, features, means, or instructions for transmitting the first uplink transmission using uplink resources provided in a first uplink grant provided in a first uplink prescheduling transmission, where the first uplink transmission includes an indication that one or more subsequent uplink transmissions from the UE will be skipped. In some examples of the method, UEs, and non-transitory computer-readable medium described herein, the indication that one or more subsequent uplink transmissions from the UE will be skipped may be provided in a medium access control (MAC) control element (CE) that indicates one or more of a quantity of skipped uplink transmissions, a cause for skipped uplink transmissions, or any combinations thereof.

A method for wireless communications by a network entity is described. The method may include obtaining a capability indication that indicates a UE supports skipping of scheduling request transmissions for one or more corresponding uplink transmissions, outputting, responsive to the capability indication, uplink prescheduling information for the UE that indicates uplink prescheduling is to be provided to the UE and one or more parameters associated with the uplink prescheduling, where the uplink prescheduling information allows the UE to skip one or more scheduling request transmissions to request uplink resources, and outputting one or more uplink prescheduling communications that provide uplink resource grants for uplink transmissions from the UE.

A network entity for wireless communications is described. The network entity may include one or more memories storing processor executable code, and one or more processors coupled with the one or more memories. The one or more processors may individually or collectively operable to execute the code to cause the network entity to obtain a capability indication that indicates a UE supports skipping of scheduling request transmissions for one or more corresponding uplink transmissions, output, responsive to the capability indication, uplink prescheduling information for the UE that indicates uplink prescheduling is to be provided to the UE and one or more parameters associated with the uplink prescheduling, where the uplink prescheduling information allows the UE to skip one or more scheduling request transmissions to request uplink resources, and output one or more uplink prescheduling communications that provide uplink resource grants for uplink transmissions from the UE.

Another network entity for wireless communications is described. The network entity may include means for obtaining a capability indication that indicates a UE supports skipping of scheduling request transmissions for one or more corresponding uplink transmissions, means for outputting, responsive to the capability indication, uplink prescheduling information for the UE that indicates uplink prescheduling is to be provided to the UE and one or more parameters associated with the uplink prescheduling, where the uplink prescheduling information allows the UE to skip one or more scheduling request transmissions to request uplink resources, and means for outputting one or more uplink prescheduling communications that provide uplink resource grants for uplink transmissions from the UE.

A non-transitory computer-readable medium storing code for wireless communications is described. The code may include instructions executable by one or more processors to obtain a capability indication that indicates a UE supports skipping of scheduling request transmissions for one or more corresponding uplink transmissions, output, responsive to the capability indication, uplink prescheduling information for the UE that indicates uplink prescheduling is to be provided to the UE and one or more parameters associated with the uplink prescheduling, where the uplink prescheduling information allows the UE to skip one or more scheduling request transmissions to request uplink resources, and output one or more uplink prescheduling communications that provide uplink resource grants for uplink transmissions from the UE.

Some examples of the method, network entities, and non-transitory computer-readable medium described herein may further include operations, features, means, or instructions for obtaining a first uplink transmission from the UE using uplink resources provided in a first uplink resource grant of a first uplink prescheduling communication.

Some examples of the method, network entities, and non-transitory computer-readable medium described herein may further include operations, features, means, or instructions for obtaining a request from the UE to adjust at least one of the one or more parameters associated with the uplink prescheduling. Some examples of the method, network entities, and non-transitory computer-readable medium described herein may further include operations, features, means, or instructions for updating at least a first parameter of the one or more parameters responsive to the request from the UE and outputting updated uplink prescheduling information to the UE. In some examples of the method, network entities, and non-transitory computer-readable medium described herein, the request may be provided subsequent to one or more uplink transmissions that use uplink resources indicated in one or more corresponding uplink prescheduling transmissions. In some examples of the method, network entities, and non-transitory computer-readable medium described herein, the request to adjust at least one of the one or more parameters associated with the uplink prescheduling may be based on one or more quality of service targets associated with uplink data that is to be transmitted from the UE.

In some examples of the method, network entities, and non-transitory computer-readable medium described herein, the one or more parameters associated with the uplink prescheduling include one or more of a type of uplink data to be transmitted, a trigger condition for initiating the uplink prescheduling, a time interval over which the uplink prescheduling will be provided, a periodicity of associated uplink transmissions, a duration of the uplink prescheduling, a transport block size of uplink grants to be provided by the uplink prescheduling, or any combinations thereof.

Some examples of the method, network entities, and non-transitory computer-readable medium described herein may further include operations, features, means, or instructions for configuring the UE to skip the one or more scheduling request transmissions based on one or more of a time interval between an arrival of uplink data in an uplink buffer at the UE and a next uplink prescheduling transmission, a quality of service associated with the uplink data, a latency target associated with the uplink data, or any combinations thereof.

Some examples of the method, network entities, and non-transitory computer-readable medium described herein may further include operations, features, means, or instructions for configuring the UE to maintain a discontinuous transmission off state at the UE during a scheduling request occasion request responsive to a determination to skip transmission of an associated scheduling request.

Some examples of the method, network entities, and non-transitory computer-readable medium described herein may further include operations, features, means, or instructions for obtaining an indication from the UE to start or stop skipping of scheduling request transmissions at the UE, the indication from the UE based on a periodicity of the uplink prescheduling, a transport block size associated with the uplink prescheduling, QCI of data to be transmitted from the UE, a DRX configuration, an uplink traffic pattern at the UE, an application associated with the data to be transmitted from the UE, or any combinations thereof.

Some examples of the method, network entities, and non-transitory computer-readable medium described herein may further include operations, features, means, or instructions for obtaining a first uplink transmission using uplink resources provided in a first uplink grant provided in a first uplink prescheduling transmission, where the first uplink transmission includes an indication that one or more subsequent uplink transmissions from the UE will be skipped. In some examples of the method, network entities, and non-transitory computer-readable medium described herein, the indication that one or more subsequent uplink transmissions from the UE will be skipped may be provided in a MAC-CE that indicates one or more of a quantity of skipped uplink transmissions, a cause for skipped uplink transmissions, or any combinations thereof.

### BRIEF DESCRIPTION OF THE DRAWINGS

FIG. 1 shows an example of a wireless communications system that supports scheduling request techniques in wireless communications in accordance with one or more aspects of the present disclosure.

FIG. 2 shows an example of a wireless communications system that supports scheduling request techniques in wireless communications in accordance with one or more aspects of the present disclosure.

FIG. 3 shows an example of a timing diagram for skipping of a scheduling request based on uplink prescheduling in accordance with one or more aspects of the present disclosure.

FIG. 4 shows an example of a process flow that supports scheduling request techniques in wireless communications in accordance with one or more aspects of the present disclosure.

FIG. 5 shows an example of a skip indication that supports scheduling request techniques in wireless communications in accordance with one or more aspects of the present disclosure.

FIGS. 6 and 7 show block diagrams of devices that support scheduling request techniques in wireless communications in accordance with one or more aspects of the present disclosure.

FIG. 8 shows a block diagram of a communications manager that supports scheduling request techniques in wireless communications in accordance with one or more aspects of the present disclosure.

FIG. 9 shows a diagram of a system including a device that supports scheduling request techniques in wireless communications in accordance with one or more aspects of the present disclosure.

FIGS. 10 and 11 show block diagrams of devices that support scheduling request techniques in wireless communications in accordance with one or more aspects of the present disclosure.

FIG. 12 shows a block diagram of a communications manager that supports scheduling request techniques in wireless communications in accordance with one or more aspects of the present disclosure.

FIG. 13 shows a diagram of a system including a device that supports scheduling request techniques in wireless communications in accordance with one or more aspects of the present disclosure.

FIGS. 14 through 26 show flowcharts illustrating methods that support scheduling request techniques in wireless communications in accordance with one or more aspects of the present disclosure.

### DETAILED DESCRIPTION

A wireless communications system may include a device, such as a user equipment (UE) or a network entity (e.g., an eNodeB (eNB), a next-generation NodeB or a giga-NodeB, either of which may be referred to as a gNB, or some other base station or network entity), that supports wireless communications using one or multiple radio access technologies. Examples of radio access technologies include 4G systems, such as LTE systems, 5G systems, which may be referred to as new radio (NR) systems, or other systems and radio technologies, including future systems and radio technologies not explicitly mentioned herein (e.g., sixth generation (6G) systems and beyond).

In some wireless communications systems, UEs may be in active communications with a network entity, and receive scheduling information (e.g., in a downlink control information (DCI) communication) that provides a grant of resources. In some cases, a UE may transmit a scheduling request to the network entity that indicates the presence of uplink data to be transmitted from the UE. For example, a scheduling request (SR) may provide a buffer status report (BSR) that indicates an amount of data that is present at the UE to be transmitted. The network entity may allocate resources for one or more uplink transmissions based on information in the SR, and provide a resource grant in a scheduling DCI transmitted to the UE. In some aspects, the network entity may transmit a resource grant to a UE in the absence of receiving a SR from the UE, by prescheduling resources for communications with the UE. Such prescheduling may enhance efficiency by reducing a quantity of SR transmissions at a UE and thus saving energy, and also by reducing latency associated with waiting for a SR occasion to transmit the associated SR and further waiting for the associated uplink grant. Such prescheduling techniques may, in some aspects, be further enhanced by providing prescheduling information to the UE that may allow the UE to determine whether to transmit a SR or not.

In accordance with various aspects discussed herein, techniques are provided for coordination between a UE and a network entity that supports uplink prescheduling communications to the UE, where the UE may skip one or more SR transmissions based on an expected uplink prescheduling communication. In some aspects, the UE may transmit a capability indication that the UE supports skipping of SR transmissions. In response to the capability indication, a network entity may provide uplink prescheduling information to the UE that indicates parameters for uplink prescheduling communications (e.g., a type of scheduling to be provided, a trigger to initiate the uplink prescheduling communications, an interval of uplink grants, a duration for which the network will send the uplink prescheduling communications, transport block size of the uplink prescheduling communications, or any combinations thereof). In some aspects, the UE may request an adjustment to one or more parameters of the uplink prescheduling information. For example, the UE may determine that an interval of the uplink prescheduling communications should be adjusted to better accommodate a traffic flow at the UE (e.g., based on historical quantities of data associated with the flow), and request an updated parameter for the uplink prescheduling information. In some aspects, the network entity and UE may negotiate one or more parameters.

In some aspects, based on the uplink prescheduling information, the network entity may transmit the uplink prescheduling communications that provide uplink grants to the UE without receiving a SR from the UE. In some aspects, in the event that a UE receives data in its uplink buffer, the UE may determine whether or not to transmit a SR based on the parameters of the uplink prescheduling information (e.g., based on an amount of time until a next SR occasion compared to an amount of time until a next uplink prescheduling communication). Additionally, or alternatively, a UE may transmit a medium access control (MAC) control element (CE) with an uplink communication that indicates the UE will skip one or more uplink transmissions that use uplink prescheduling, and the network entity may adjust one or more parameters provided in the uplink prescheduling information based on the indication in the MAC-CE.

Various techniques as discussed herein may provide one or more UE and network enhancements and efficiencies. For example, latency may be reduced for uplink communications from a UE by reducing an amount of time between arrival of uplink data to be transmitted and receipt of a grant of uplink resources. Further, power consumption at the UE may be reduced through transmission of fewer SRs. Additionally, a UE may maintain a discontinuous transmission (DTX) or discontinuous reception (DRX) state for a longer time duration due to skipping of one or more SR transmissions, which may further reduce power consumption at the UE. Thus, such techniques may provide for enhanced reliability and efficiency of communications.

Aspects of the disclosure are initially described in the context of wireless communications systems. Aspects of the disclosure are further illustrated by and described with reference to timing diagrams, process flows, apparatus diagrams, system diagrams, and flowcharts that relate to scheduling request techniques in wireless communications.

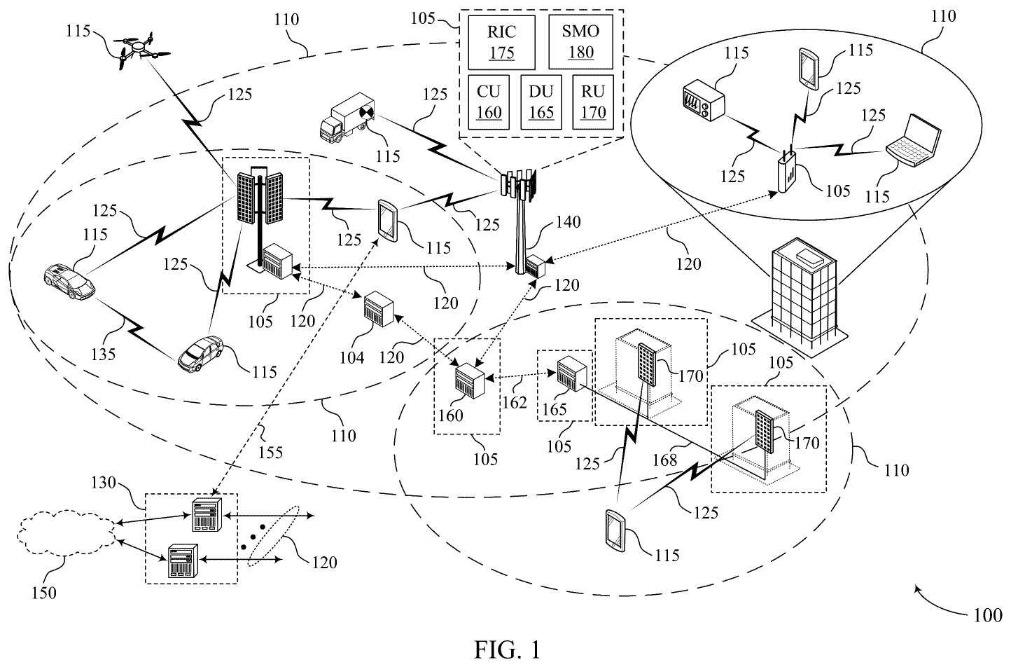

FIG. 1 shows an example of a wireless communications system 100 that supports scheduling request techniques in wireless communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support scheduling request techniques in wireless communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, described techniques provide for coordination between a UE 115 and a network entity 105 that supports uplink prescheduling communications to the UE 115, where the UE 115 may skip one or more SR transmissions based on an expected uplink prescheduling communication. In some aspects, a UE 115 may transmit a capability indication of support for skipping of SR transmissions. In response to the capability indication, a network entity 105 may provide uplink prescheduling information to the UE 115 that indicates parameters for uplink prescheduling communications. The network entity 105 may transmit the uplink prescheduling communications that provide uplink grants to the UE 115 without receiving a SR from the UE 115, in accordance with the uplink prescheduling information.

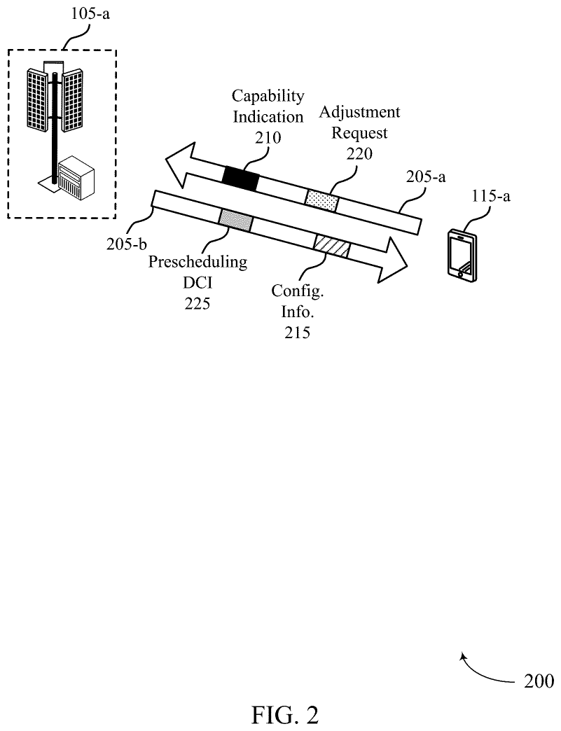

FIG. 2 shows an example of a wireless communications system 200 that supports scheduling request techniques in wireless communications in accordance with one or more aspects of the present disclosure. The wireless communications system 200 may implement or be implemented by aspects of the wireless communications system 100. For example, the wireless communications system 200 may include a network entity 105-a and a UE 115-a, which may be examples of a network entity 105 (e.g., an RU 170, a DU 165, a CU 160, a base station 140, or some combination thereof) and a UE 115 as described with reference to FIG. 1.

The network entity 105-a and the UE 115-a may communicate with one another via an uplink channel 205-a and a downlink channel 205-b, which may be examples or components of a communication link 125 as described with reference to FIG. 1. The UE 115-a and network entity 105-a may support techniques for providing prescheduling information and skipping SR transmissions. By providing techniques for configuration of prescheduling information and skipping SR transmissions, the UE 115-a and network entity 105-a may promote resource efficiency, reduced latency, and enhanced reliability, while also providing for reduced power consumption for the UE 115-a.

In the example of FIG. 2, the UE 115-a may transmit a capability indication 210 to the network entity 105-a that may indicate a capability for skipping SR transmissions based on uplink prescheduling. In some aspects, the capability indication may be provided in one or more UE 115-a capability communications provided to the network entity 105-a via RRC signaling, in one or more MAC-CEs, or any combinations thereof. The network entity 105-a may receive the capability indication 210 and configure uplink prescheduling information that indicates uplink prescheduling is to be provided to the UE 115-a, and one or more parameters associated with the uplink prescheduling. The network entity 105-a may provide the uplink prescheduling information to the UE 115-a in configuration information 215.

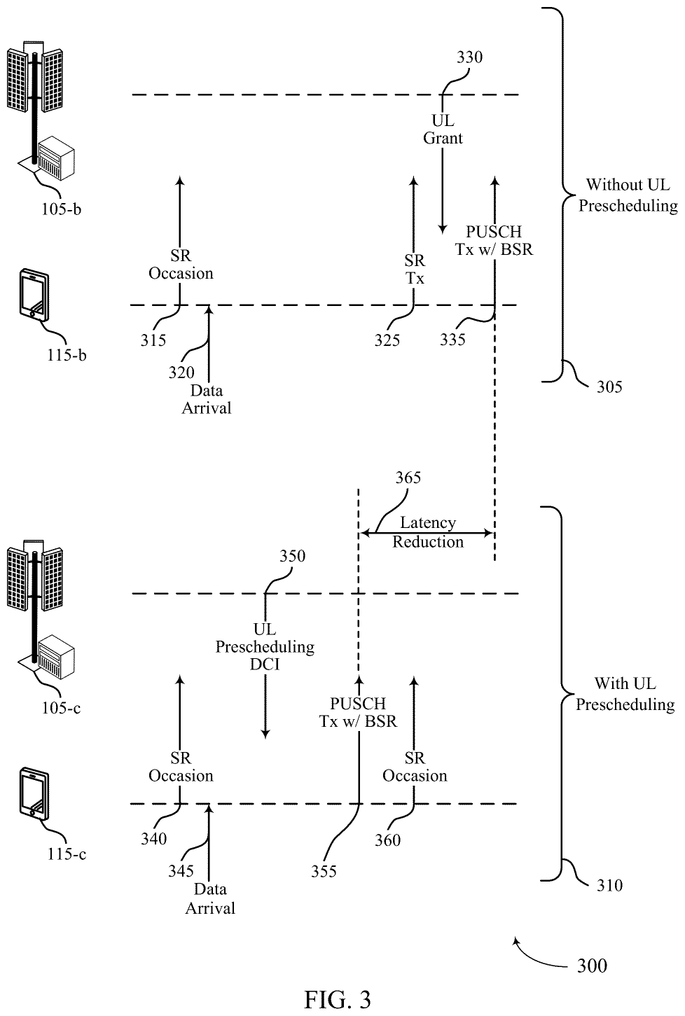

In some aspects, the UE 115-a may receive the uplink prescheduling information and determine that an adjustment to one or more parameters of the uplink prescheduling information would be beneficial. For example, the uplink prescheduling information may indicate a time interval for uplink prescheduling that is longer than a time interval at which data is expected to arrive at the UE 115-a for transmission, and the UE 115-a may determine that an adjustment to reduce the time interval would better fit the expected data flow. The UE 115-a in such cases may transmit an adjustment request 220 to the network entity 105-a. The network entity 105-a, based on the adjustment request 220, may maintain or adjust the one or more parameters, which may be provided in updated configuration information 215, for example. Based on the uplink prescheduling information the network entity 105-a may transmit one or more prescheduling DCIs 225 to the UE 115-a, that include a grant of uplink resources to the UE 115-a. The UE 115-a, based on the uplink prescheduling information, may determine to skip one or more SR transmissions. FIGS. 3 through 5 provide some examples of uplink prescheduling information and skipping of SR transmissions for various aspects.

FIG. 3 shows an example of a timing diagram 300 for skipping of a SR based on uplink prescheduling in accordance with one or more aspects of the present disclosure. The timing diagram 300 may be implemented by aspects of the wireless communications system 100 or 200. For example, UEs 115-b and 115-c, and network entities 105-b and 105-c, which may be examples of UEs 115 and network entities 105 of FIGS. 1 and 2, may implement skipping of SRs based on uplink prescheduling.

In a first example 305, a first network entity 105-b and a first UE 115-b may communicate without uplink prescheduling. In this example, the first network entity 105-b may configure periodic SR occasions that may be used by the first UE 115-b to transmit SRs after arrival of data at the first UE 115-b. In this example, a data arrival 320 at the first UE 115-b may occur after a first SR occasion 315, and the first UE 115-a may transmit a SR 325 in a second SR occasion. The first network entity 105-b may receive the SR 325, and allocate uplink resources to the first UE 115-b that are indicated in uplink grant 330 that is transmitted to the first UE 115-b. The first UE 115-b may then transmit an uplink transmission, such as a physical uplink shared channel (PUSCH) transmission 335, which may include a BSR that may be used for subsequent uplink grants.

In a second example 310, a second network entity 105-c and a second UE 115-c may communicate using uplink prescheduling. In this example, the second network entity 105-c may configure periodic SR occasions 340 and 360 that may be used by the second UE 115-c to transmit SRs after data arrival 345 at the second UE 115-c. Further, in the second example 310, the second network entity 105-c may configure uplink prescheduling, and may transmit an uplink prescheduling DCI 350 that may allocate uplink resources to the second UE 115-c. In accordance with the received uplink grant, the second UE 115-c may transmit an uplink transmission, such as a PUSCH transmission 355, which may include a BSR that may be used for subsequent uplink grants. Because the second UE 115-c received the uplink prescheduling DCI 350, a SR transmission in the SR occasion 360 is skipped, and the PUSCH transmission 355 is transmitted sooner than the PUSCH transmission 335 in the first example 305, thus resulting in a latency reduction 365. Further, by skipping SR transmissions the second UE 115-c may have reduced power consumption due to fewer uplink transmissions and, in some cases, being able to remain in a DTX/DRX state for a longer period of time. Further, reliability may be enhanced by providing prescheduling parameters to the second UE 115-c such that a miss-identification of an expected prescheduling grant may be avoided (e.g., due to the second UE 115-c misidentifying an uplink prescheduling interval, not sending a SR, and thus not receiving an uplink grant, which may result in throughput degradation or packet loss).

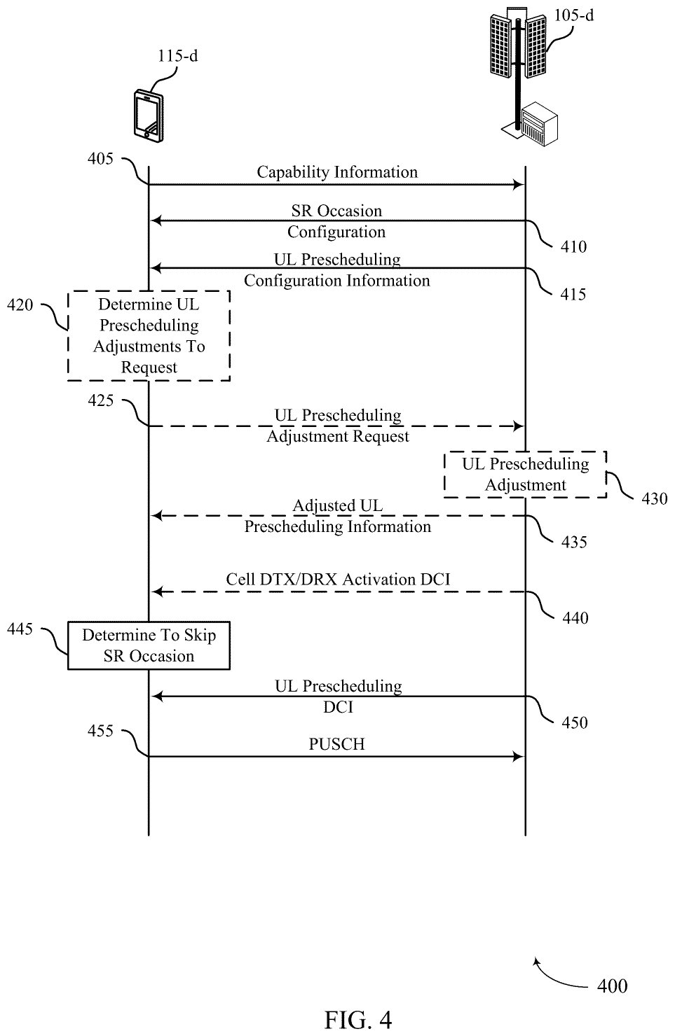

FIG. 4 shows an example of a process flow 400 that supports scheduling request techniques in wireless communications in accordance with one or more aspects of the present disclosure. The process flow 400 may include a network entity 105-d and a UE 115-d, which may be examples of a network entity 105 and a UE 115 as described with reference to FIGS. 1 through 3. The process flow 400 may be implemented by the network entity 105-d and the UE 115-d where the uplink prescheduling may be used to allow for skipping of SR transmissions by the UE 115-d. Such techniques may provide for power savings and latency reductions associated with uplink grants being provided to the UE 115-d, while also enabling confirmation that UE 115-d is aware of the prescheduling information parameters, which may thereby enhance overall network efficiency and user experience. In the following description of the process flow 400, the operations between the network entity 105-d and the UE 115-d may be performed in a different order than the example order shown. Some operations may be omitted from the process flow 400, and other operations may be added to the process flow 400.

At 405, the UE 115-d may transmit a capability information message that indicates to the network entity 105-d a capability of the UE 115-d for skipping SR transmissions based on uplink prescheduling. In some cases, the capability information message may be transmitted via RRC signaling, one or more MAC-CEs, uplink control information (UCI), or any combinations thereof.

At 410, the network entity 105-d may transmit, and the UE 115-d may receive, a SR occasion configuration. The SR occasion configuration may provide parameters for SR occasions for transmission of SRs from the UE 115-d. In some cases, the SR occasion configuration may be transmitted via RRC signaling, one or more MAC-CEs, DCI, or any combinations thereof.

At 415, the network entity 105-d may transmit, and the UE 115-d may receive, uplink prescheduling configuration information. In some aspects, the uplink prescheduling configuration information may indicate parameters associated with uplink prescheduling DCI transmissions, such as a trigger for uplink prescheduling (e.g., based on a BSR provided by the UE 115-d indicating an amount of uplink data to be transmitted exceeds a threshold value), an interval of uplink prescheduling DCI transmissions (e.g., every X slots, where X is a positive integer), a duration over which uplink prescheduling DCI transmissions will be transmitted (e.g., a quantity of slots or number of milliseconds), or any combinations thereof. In some cases, the uplink prescheduling configuration information may be transmitted via RRC signaling, one or more MAC-CEs, DCI, or any combinations thereof.

At 420, optionally, the UE 115-d may determine uplink prescheduling adjustments that are to be requested. In some cases, the UE 115-d may receive the uplink prescheduling configuration information and compare the one or more parameters to expected uplink transmission characteristics (e.g., based on historical data flows), and determine one or more parameter adjustments that better suit the expected uplink transmission characteristics (e.g., an adjusted interval for DCI transmissions, an adjusted duration of uplink prescheduling, etc.). In some cases, the UE 115-d may determine the one or more adjustments based on a quality of service (QOS) associated with an application that is providing data to be transmitted.

At 425, in cases where the UE 115-d determines one or more adjustments to the uplink prescheduling parameters, the UE may transmit an uplink prescheduling adjustment request. In some cases, the uplink prescheduling adjustment request may be transmitted via RRC signaling, one or more MAC-CEs, UCI, or any combinations thereof. At 430, the network entity 105-d may receive the uplink prescheduling adjustment request and make one or more uplink prescheduling adjustments. At 435, the network entity 105-d may transmit, and the UE 115-d may receive, adjusted uplink prescheduling information (e.g., via RRC, MAC-CE, DCI, or any combinations thereof).

At 440, optionally, the network entity 105-d may transmit a cell DTX/DRX activation DCI that activates a DTX/DRX mode at the UE 115-d in which the UE 115-d powers down one or more transmit/receive components to save power.

At 445, the UE 115-d may determine to skip a SR occasion that is configured for a SR transmission. For example, uplink data may arrive at the UE 115-d for uplink transmission. The UE 115-a may check a time interval of next uplink prescheduling DCI and, if the time interval is below a threshold value (e.g., a value related to application QoS), the UE 115-d may skip a SR transmission in a SR occasion, and remain in DTX/DRX off mode if such a mode is active. In some aspects, the skipping of a SR transmission may be based on the network entity 105-d indicating support of SR skipping (e.g., as indicated by the uplink prescheduling configuration), any adjustment of a SR skip condition, and a trigger to start or stop skipping of SR transmissions (e.g., based on configured trigger conditions such as a type of data to be transmitted, an amount of data to be transmitted, a data priority, QoS of the data, a DTX/DRX mode of the UE 115-d, or any combinations thereof). In some aspects, the uplink prescheduling configuration may include a periodicity, transport block size (TBS), quality of service class identifier (QCI), DTX/DRX configuration, traffic pattern, application that is providing the uplink data, or any combinations thereof.

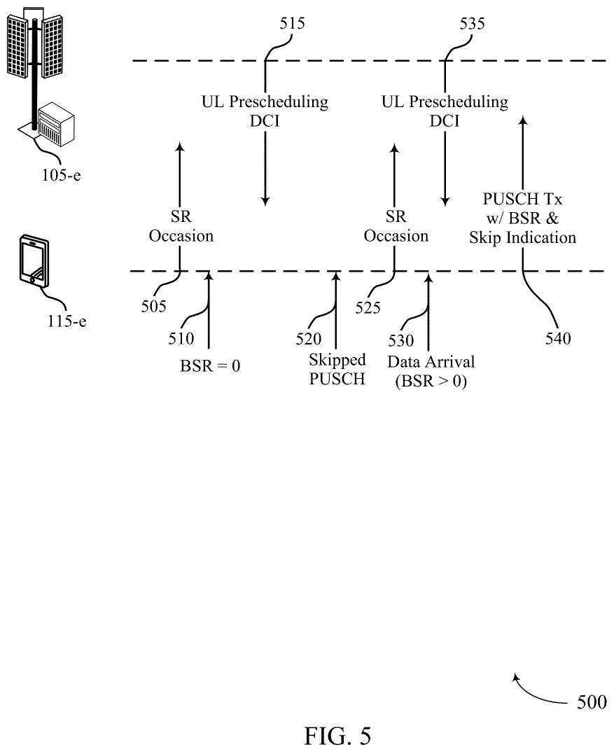

At 450, the network entity 105-d may transmit, and the UE 115-d may receive, an uplink prescheduling DCI. The uplink prescheduling DCI may include an uplink resource grant for the UE 115-d to transmit one or more uplink transmissions. At 455, the UE 115-d may transmit, and the network entity 105-d may receive, an uplink transmission (e.g., a PUSCH transmission with a BSR) via the allocated uplink resources. In some aspects, an uplink transmission may include an indication of whether one or more subsequent uplink transmissions is to be skipped at the UE 115-d, such as discussed with reference to the example of FIG. 5.

FIG. 5 shows an example of a skip indication 500 that supports scheduling request techniques in wireless communications in accordance with one or more aspects of the present disclosure. The skip indication 500 may be implemented by aspects of the wireless communications systems 100 or 200. For example, UE 115-e and network entity 105-e, which may be examples of UEs 115 and network entities 105 of FIGS. 1 through 4, may implement skipping of SRs based on uplink prescheduling, and UE 115-e may provide an indication of whether one or more uplink transmissions will be skipped.

In the example of FIG. 5, network entity 105-e and UE 115-e may communicate using uplink prescheduling as discussed herein. For example, a first SR occasion 505 may be configured, and the UE 115-e may not transmit a SR due to no uplink data being present, such as indicated at 510 where the UE BSR is zero. The network entity 105-e may transmit a first uplink prescheduling DCI 515 and, due to the empty buffer, the UE 115-e may skip the associated PUSCH transmission 520. A subsequent SR occasion 525 may also be skipped due to the empty buffer at the UE 115-e.

In this example, data arrival 530 at the UE 115-e may result in a positive value for the BSR. As discussed herein, the UE 115-e may determine whether to transmit a SR or not, such as based on a time until a second uplink prescheduling DCI 535. In this example, the time until the second uplink prescheduling DCI 535 may be less than a threshold value, and the UE 115-e may rely on the uplink grant from the second uplink prescheduling DCI 535. In this example, the UE 115-e may transmit the uplink transmission, such as a PUSCH transmission 540, which may include a BSR and a skip indication that indicates whether one or more subsequent prescheduling transmissions is to be skipped. In some aspects, the skip indication may be carried in a MAC-CE in the PUSCH transmission 540. Such an indication by the UE 115-d may allow the network entity 105-e to be aware that the UE 115-e will skip SR and uplink PUSCH transmissions, and thus adjust UL prescheduling accordingly (e.g., by skipping an associated uplink resource allocation for one or more intervals of uplink prescheduling, and skipping transmission of an associated uplink prescheduling DCI). Additionally, or alternatively, the UE 115-e may indicate statistics of skipped uplink transmissions (e.g., a quantity of transmissions to skip), provide a cause for the skipping of uplink transmissions (e.g., lack of data, presence of lower priority data, etc.) via MAC-CE. In some aspects, the skipping indication may be based at least in part on a transport block size associated with the uplink prescheduling grants, an uplink traffic predication or expected data flow for uplink traffic, or any combination thereof. In some aspects, the network entity 105-e may adjust both the uplink prescheduling and the SR configuration based on the indication from the UE 115-e (e.g., by reusing the resources configured for the prescheduling DCI and SR occasion for communications with a different UE).

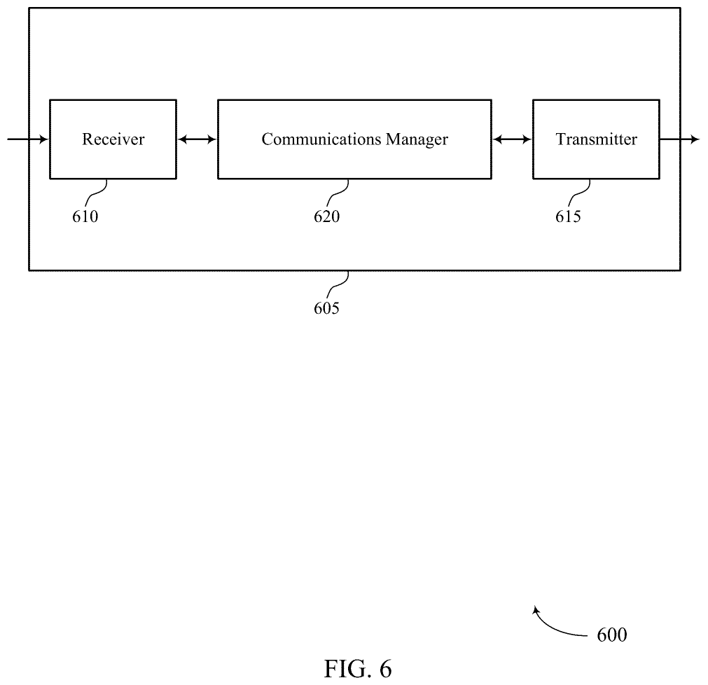

FIG. 6 shows a block diagram 600 of a device 605 that supports scheduling request techniques in wireless communications in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to scheduling request techniques in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to scheduling request techniques in wireless communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of scheduling request techniques in wireless communications as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting a capability indication that indicates that the UE supports skipping of scheduling request transmissions for one or more corresponding uplink transmissions. The communications manager 620 is capable of, configured to, or operable to support a means for receiving uplink prescheduling information that indicates uplink prescheduling is to be provided to the UE and one or more parameters associated with the uplink prescheduling. The communications manager 620 is capable of, configured to, or operable to support a means for determining, when uplink data is present at the UE to be transmitted in a first uplink transmission, to skip a transmission of a first scheduling request to request uplink resources for the first uplink transmission, where the determination to skip the transmission of the first scheduling request is based on the one or more parameters associated with the uplink prescheduling.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for uplink prescheduling and skipping of SR transmissions, which may reduce latency and reduce power consumption, and thereby provide for enhanced efficiency of communications.

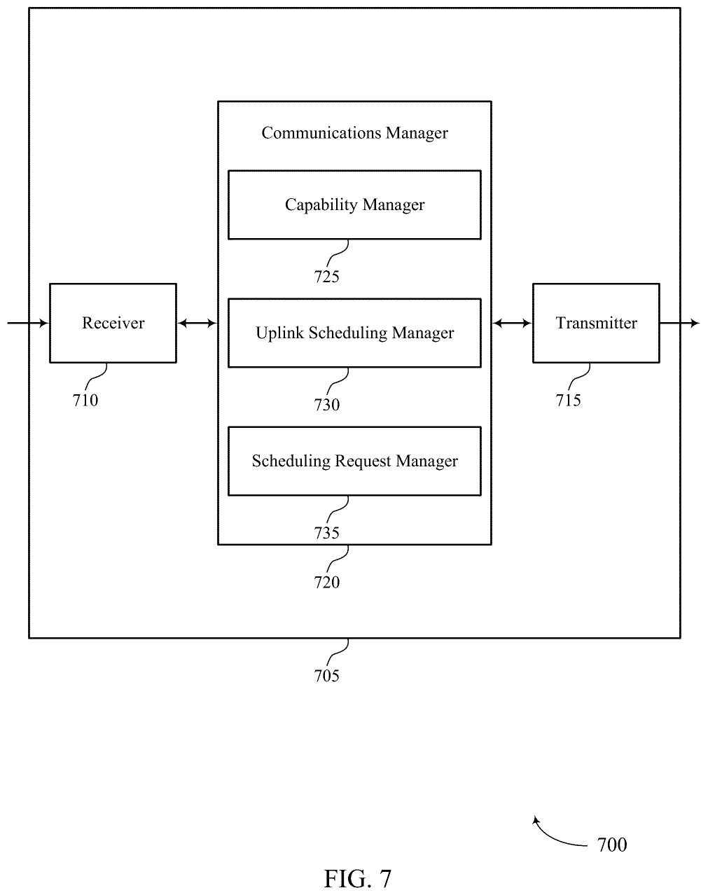

FIG. 7 shows a block diagram 700 of a device 705 that supports scheduling request techniques in wireless communications in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to scheduling request techniques in wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to scheduling request techniques in wireless communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of scheduling request techniques in wireless communications as described herein. For example, the communications manager 720 may include a capability manager 725, an uplink scheduling manager 730, a scheduling request manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The capability manager 725 is capable of, configured to, or operable to support a means for transmitting a capability indication that indicates that the UE supports skipping of scheduling request transmissions for one or more corresponding uplink transmissions. The uplink scheduling manager 730 is capable of, configured to, or operable to support a means for receiving uplink prescheduling information that indicates uplink prescheduling is to be provided to the UE and one or more parameters associated with the uplink prescheduling. The scheduling request manager 735 is capable of, configured to, or operable to support a means for determining, when uplink data is present at the UE to be transmitted in a first uplink transmission, to skip a transmission of a first scheduling request to request uplink resources for the first uplink transmission, where the determination to skip the transmission of the first scheduling request is based on the one or more parameters associated with the uplink prescheduling.

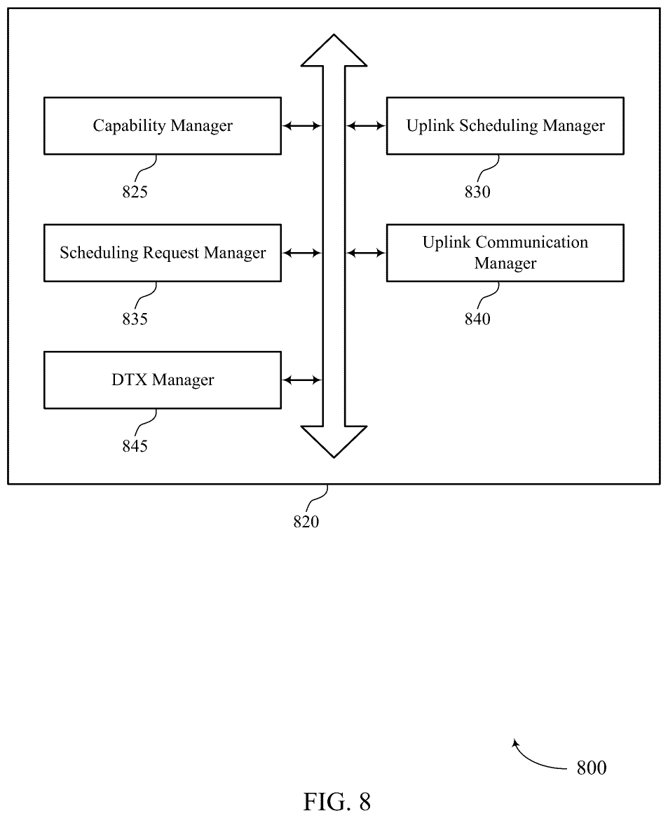

FIG. 8 shows a block diagram 800 of a communications manager 820 that supports scheduling request techniques in wireless communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of scheduling request techniques in wireless communications as described herein. For example, the communications manager 820 may include a capability manager 825, an uplink scheduling manager 830, a scheduling request manager 835, an uplink communication manager 840, a DTX manager 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The capability manager 825 is capable of, configured to, or operable to support a means for transmitting a capability indication that indicates that the UE supports skipping of scheduling request transmissions for one or more corresponding uplink transmissions. The uplink scheduling manager 830 is capable of, configured to, or operable to support a means for receiving uplink prescheduling information that indicates uplink prescheduling is to be provided to the UE and one or more parameters associated with the uplink prescheduling. The scheduling request manager 835 is capable of, configured to, or operable to support a means for determining, when uplink data is present at the UE to be transmitted in a first uplink transmission, to skip a transmission of a first scheduling request to request uplink resources for the first uplink transmission, where the determination to skip the transmission of the first scheduling request is based on the one or more parameters associated with the uplink prescheduling.

In some examples, the uplink scheduling manager 830 is capable of, configured to, or operable to support a means for receiving a first uplink prescheduling transmission that provides a first uplink grant to the UE. In some examples, the uplink communication manager 840 is capable of, configured to, or operable to support a means for transmitting the first uplink transmission using uplink resources provided in the first uplink grant.

In some examples, the uplink scheduling manager 830 is capable of, configured to, or operable to support a means for transmitting a request to adjust at least one of the one or more parameters associated with the uplink prescheduling. In some examples, the uplink scheduling manager 830 is capable of, configured to, or operable to support a means for receiving updated uplink prescheduling information based on the request. In some examples, the request is transmitted subsequent to one or more uplink transmissions that use uplink resources indicated in one or more corresponding uplink prescheduling transmissions. In some examples, the request to adjust at least one of the one or more parameters associated with the uplink prescheduling is based on one or more quality of service targets associated with uplink data that is to be transmitted from the UE. In some examples, the one or more parameters associated with the uplink prescheduling include one or more of a type of uplink data to be transmitted, a trigger condition for initiating the uplink prescheduling, a time interval over which the uplink prescheduling will be provided, a periodicity of associated uplink transmissions, a duration of the uplink prescheduling, a transport block size of uplink grants to be provided by the uplink prescheduling, or any combinations thereof.

In some examples, the scheduling request manager 835 is capable of, configured to, or operable to support a means for receiving uplink data to be transmitted in an uplink buffer at the UE, and where the determining is further based on one or more of a time interval between an arrival of the uplink data in the uplink buffer and a next uplink prescheduling transmission, a quality of service associated with the uplink data, a latency target associated with the uplink data, or any combinations thereof.

In some examples, the DTX manager 845 is capable of, configured to, or operable to support a means for maintaining a discontinuous transmission off state at the UE during a scheduling request occasion associated with the first scheduling request responsive to determining to skip the transmission of the first scheduling request.

In some examples, the uplink communication manager 840 is capable of, configured to, or operable to support a means for receiving, subsequent to the first uplink transmission, uplink data to be transmitted in a second uplink transmission from the UE. In some examples, the scheduling request manager 835 is capable of, configured to, or operable to support a means for transmitting a second scheduling request to request uplink resources for the second uplink transmission based on a time interval to a next uplink prescheduling transmission being greater than a threshold value.

In some examples, the scheduling request manager 835 is capable of, configured to, or operable to support a means for transmitting an indication to start or stop skipping of scheduling request transmissions at the UE based on a periodicity of the uplink prescheduling, a transport block size associated with the uplink prescheduling, quality of service class identifier (QCI) of data to be transmitted from the UE, a DRX configuration, an uplink traffic pattern at the UE, an application associated with the data to be transmitted from the UE, or any combinations thereof.

In some examples, the uplink communication manager 840 is capable of, configured to, or operable to support a means for transmitting the first uplink transmission using uplink resources provided in a first uplink grant provided in a first uplink prescheduling transmission, where the first uplink transmission includes an indication that one or more subsequent uplink transmissions from the UE will be skipped. In some examples, the indication that one or more subsequent uplink transmissions from the UE will be skipped is provided in a MAC-CE that indicates one or more of a quantity of skipped uplink transmissions, a cause for skipped uplink transmissions, or any combinations thereof.

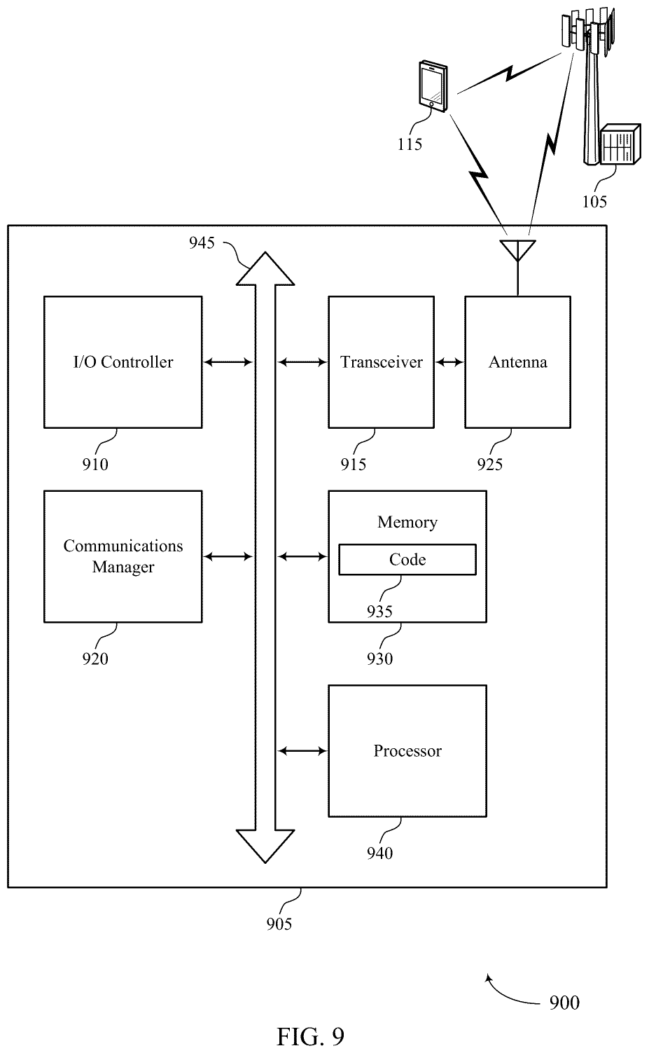

FIG. 9 shows a diagram of a system 900 including a device 905 that supports scheduling request techniques in wireless communications in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting scheduling request techniques in wireless communications). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for transmitting a capability indication that indicates that the UE supports skipping of scheduling request transmissions for one or more corresponding uplink transmissions. The communications manager 920 is capable of, configured to, or operable to support a means for receiving uplink prescheduling information that indicates uplink prescheduling is to be provided to the UE and one or more parameters associated with the uplink prescheduling. The communications manager 920 is capable of, configured to, or operable to support a means for determining, when uplink data is present at the UE to be transmitted in a first uplink transmission, to skip a transmission of a first scheduling request to request uplink resources for the first uplink transmission, where the determination to skip the transmission of the first scheduling request is based on the one or more parameters associated with the uplink prescheduling.

By including or configuring the communications manager 920 in accordance with examples as described herein, the device 905 may support techniques for uplink prescheduling and skipping of SR transmissions, which may reduce latency and reduce power consumption, and thereby provide for enhanced efficiency of communications.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of scheduling request techniques in wireless communications as described herein, or the at least one processor 940 and the at least one memory 930 may be otherwise configured to, individually or collectively, perform or support such operations.

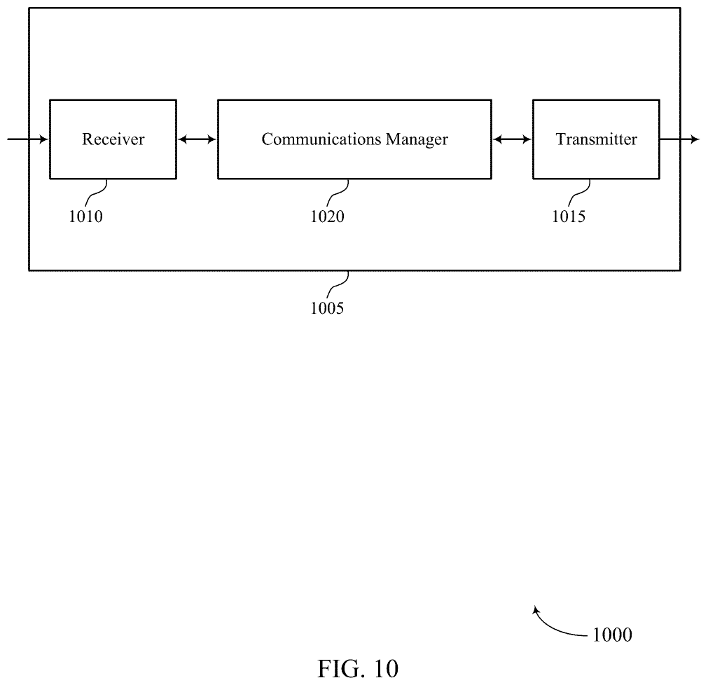

FIG. 10 shows a block diagram 1000 of a device 1005 that supports scheduling request techniques in wireless communications in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of scheduling request techniques in wireless communications as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for obtaining a capability indication that indicates a UE supports skipping of scheduling request transmissions for one or more corresponding uplink transmissions. The communications manager 1020 is capable of, configured to, or operable to support a means for outputting, responsive to the capability indication, uplink prescheduling information for the UE that indicates uplink prescheduling is to be provided to the UE and one or more parameters associated with the uplink prescheduling, where the uplink prescheduling information allows the UE to skip one or more scheduling request transmissions to request uplink resources. The communications manager 1020 is capable of, configured to, or operable to support a means for outputting one or more uplink prescheduling communications that provide uplink resource grants for uplink transmissions from the UE.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for uplink prescheduling and skipping of SR transmissions, which may reduce latency and reduce power consumption, and thereby provide for enhanced efficiency of communications.

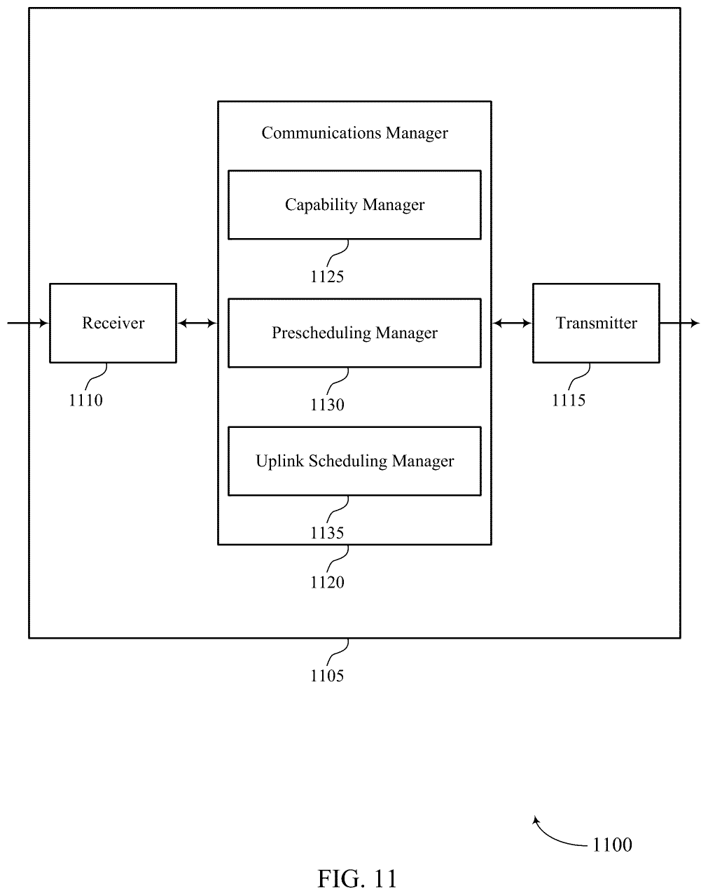

FIG. 11 shows a block diagram 1100 of a device 1105 that supports scheduling request techniques in wireless communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of scheduling request techniques in wireless communications as described herein. For example, the communications manager 1120 may include a capability manager 1125, a prescheduling manager 1130, an uplink scheduling manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The capability manager 1125 is capable of, configured to, or operable to support a means for obtaining a capability indication that indicates a UE supports skipping of scheduling request transmissions for one or more corresponding uplink transmissions. The prescheduling manager 1130 is capable of, configured to, or operable to support a means for outputting, responsive to the capability indication, uplink prescheduling information for the UE that indicates uplink prescheduling is to be provided to the UE and one or more parameters associated with the uplink prescheduling, where the uplink prescheduling information allows the UE to skip one or more scheduling request transmissions to request uplink resources. The uplink scheduling manager 1135 is capable of, configured to, or operable to support a means for outputting one or more uplink prescheduling communications that provide uplink resource grants for uplink transmissions from the UE.

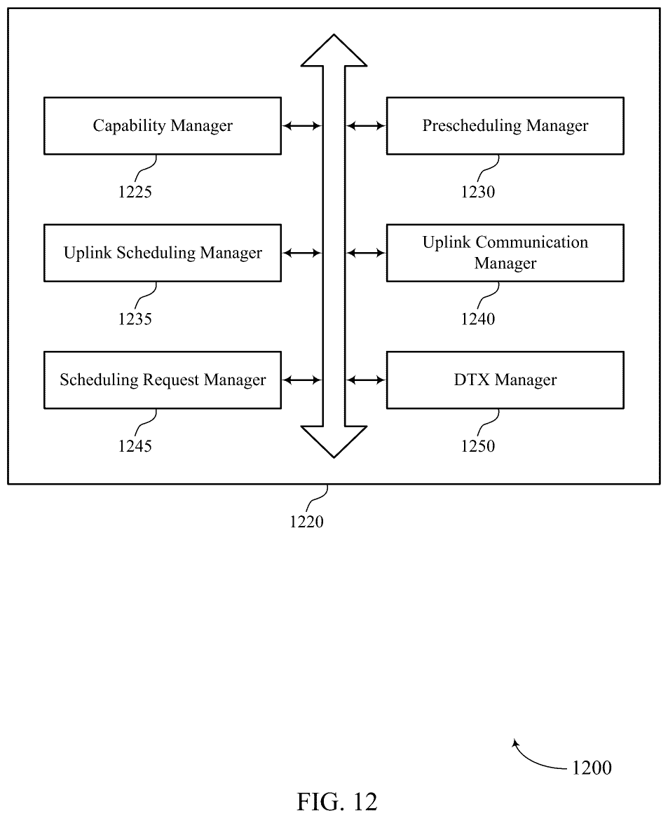

FIG. 12 shows a block diagram 1200 of a communications manager 1220 that supports scheduling request techniques in wireless communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of scheduling request techniques in wireless communications as described herein. For example, the communications manager 1220 may include a capability manager 1225, a prescheduling manager 1230, an uplink scheduling manager 1235, an uplink communication manager 1240, a scheduling request manager 1245, a DTX manager 1250, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The capability manager 1225 is capable of, configured to, or operable to support a means for obtaining a capability indication that indicates a UE supports skipping of scheduling request transmissions for one or more corresponding uplink transmissions. The prescheduling manager 1230 is capable of, configured to, or operable to support a means for outputting, responsive to the capability indication, uplink prescheduling information for the UE that indicates uplink prescheduling is to be provided to the UE and one or more parameters associated with the uplink prescheduling, where the uplink prescheduling information allows the UE to skip one or more scheduling request transmissions to request uplink resources. The uplink scheduling manager 1235 is capable of, configured to, or operable to support a means for outputting one or more uplink prescheduling communications that provide uplink resource grants for uplink transmissions from the UE.

In some examples, the uplink communication manager 1240 is capable of, configured to, or operable to support a means for obtaining a first uplink transmission from the UE using uplink resources provided in a first uplink resource grant of a first uplink prescheduling communication.

In some examples, the prescheduling manager 1230 is capable of, configured to, or operable to support a means for obtaining a request from the UE to adjust at least one of the one or more parameters associated with the uplink prescheduling. In some examples, the prescheduling manager 1230 is capable of, configured to, or operable to support a means for updating at least a first parameter of the one or more parameters responsive to the request from the UE. In some examples, the prescheduling manager 1230 is capable of, configured to, or operable to support a means for outputting updated uplink prescheduling information to the UE. In some examples, the request is provided subsequent to one or more uplink transmissions that use uplink resources indicated in one or more corresponding uplink prescheduling transmissions. In some examples, the request to adjust at least one of the one or more parameters associated with the uplink prescheduling is based on one or more quality of service targets associated with uplink data that is to be transmitted from the UE. In some examples, the one or more parameters associated with the uplink prescheduling include one or more of a type of uplink data to be transmitted, a trigger condition for initiating the uplink prescheduling, a time interval over which the uplink prescheduling will be provided, a periodicity of associated uplink transmissions, a duration of the uplink prescheduling (e.g., 100 ms or 500 ms), a transport block size of uplink grants to be provided by the uplink prescheduling, or any combinations thereof.

In some examples, the scheduling request manager 1245 is capable of, configured to, or operable to support a means for configuring the UE to skip the one or more scheduling request transmissions based on one or more of a time interval between an arrival of uplink data in an uplink buffer at the UE and a next uplink prescheduling transmission, a quality of service associated with the uplink data, a latency target associated with the uplink data, or any combinations thereof.

In some examples, the DTX manager 1250 is capable of, configured to, or operable to support a means for configuring the UE to maintain a discontinuous transmission off state at the UE during a scheduling request occasion request responsive to a determination to skip transmission of an associated scheduling request.

In some examples, the prescheduling manager 1230 is capable of, configured to, or operable to support a means for obtaining an indication from the UE to start or stop skipping of scheduling request transmissions at the UE, the indication from the UE based on a periodicity of the uplink prescheduling, a transport block size associated with the uplink prescheduling, quality of service class identifier (QCI) of data to be transmitted from the UE, a DRX configuration, an uplink traffic pattern at the UE, an application associated with the data to be transmitted from the UE, or any combinations thereof.

In some examples, the uplink communication manager 1240 is capable of, configured to, or operable to support a means for obtaining a first uplink transmission using uplink resources provided in a first uplink grant provided in a first uplink prescheduling transmission, where the first uplink transmission includes an indication that one or more subsequent uplink transmissions from the UE will be skipped. In some examples, the indication that one or more subsequent uplink transmissions from the UE will be skipped is provided in a MAC-CE that indicates one or more of a quantity of skipped uplink transmissions, a cause for skipped uplink transmissions, or any combinations thereof.

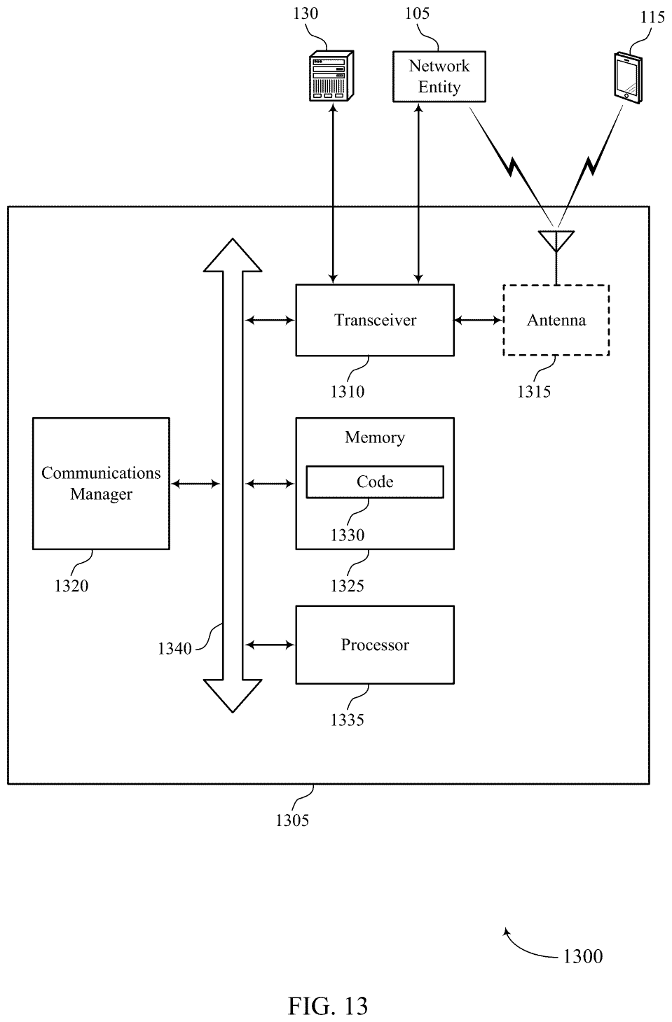

FIG. 13 shows a diagram of a system 1300 including a device 1305 that supports scheduling request techniques in wireless communications in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting scheduling request techniques in wireless communications). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for obtaining a capability indication that indicates a UE supports skipping of scheduling request transmissions for one or more corresponding uplink transmissions. The communications manager 1320 is capable of, configured to, or operable to support a means for outputting, responsive to the capability indication, uplink prescheduling information for the UE that indicates uplink prescheduling is to be provided to the UE and one or more parameters associated with the uplink prescheduling, where the uplink prescheduling information allows the UE to skip one or more scheduling request transmissions to request uplink resources. The communications manager 1320 is capable of, configured to, or operable to support a means for outputting one or more uplink prescheduling communications that provide uplink resource grants for uplink transmissions from the UE.

By including or configuring the communications manager 1320 in accordance with examples as described herein, the device 1305 may support techniques for uplink prescheduling and skipping of SR transmissions, which may reduce latency and reduce power consumption, and thereby provide for enhanced efficiency of communications.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of scheduling request techniques in wireless communications as described herein, or the at least one processor 1335 and the at least one memory 1325 may be otherwise configured to, individually or collectively, perform or support such operations.

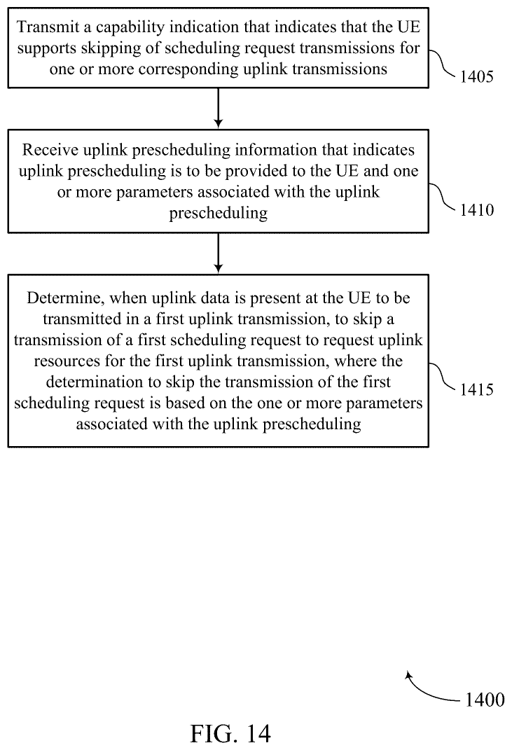

FIG. 14 shows a flowchart illustrating a method 1400 that supports scheduling request techniques in wireless communications in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting a capability indication that indicates that the UE supports skipping of scheduling request transmissions for one or more corresponding uplink transmissions. The operations of block 1405 may be performed in accordance with examples as disclosed herein. In some examples, aspects of the operations of 1405 may be performed by a capability manager 825 as described with reference to FIG. 8.

At 1410, the method may include receiving uplink prescheduling information that indicates uplink prescheduling is to be provided to the UE and one or more parameters associated with the uplink prescheduling. The operations of block 1410 may be performed in accordance with examples as disclosed herein. In some examples, aspects of the operations of 1410 may be performed by an uplink scheduling manager 830 as described with reference to FIG. 8.

At 1415, the method may include determining, when uplink data is present at the UE to be transmitted in a first uplink transmission, to skip a transmission of a first scheduling request to request uplink resources for the first uplink transmission, where the determination to skip the transmission of the first scheduling request is based on the one or more parameters associated with the uplink prescheduling. The operations of block 1415 may be performed in accordance with examples as disclosed herein. In some examples, aspects of the operations of 1415 may be performed by a scheduling request manager 835 as described with reference to FIG. 8.

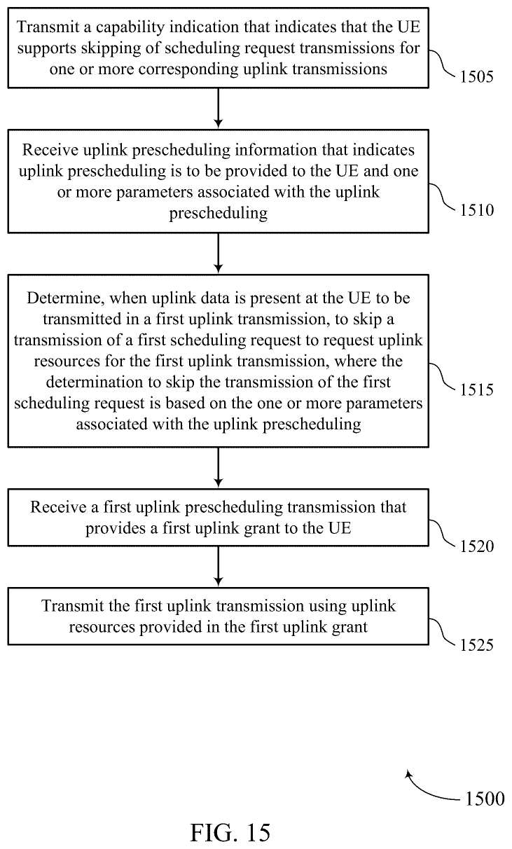

FIG. 15 shows a flowchart illustrating a method 1500 that supports scheduling request techniques in wireless communications in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting a capability indication that indicates that the UE supports skipping of scheduling request transmissions for one or more corresponding uplink transmissions. The operations of block 1505 may be performed in accordance with examples as disclosed herein. In some examples, aspects of the operations of 1505 may be performed by a capability manager 825 as described with reference to FIG. 8.

At 1510, the method may include receiving uplink prescheduling information that indicates uplink prescheduling is to be provided to the UE and one or more parameters associated with the uplink prescheduling. The operations of block 1510 may be performed in accordance with examples as disclosed herein. In some examples, aspects of the operations of 1510 may be performed by an uplink scheduling manager 830 as described with reference to FIG. 8.

At 1515, the method may include determining, when uplink data is present at the UE to be transmitted in a first uplink transmission, to skip a transmission of a first scheduling request to request uplink resources for the first uplink transmission, where the determination to skip the transmission of the first scheduling request is based on the one or more parameters associated with the uplink prescheduling. The operations of block 1515 may be performed in accordance with examples as disclosed herein. In some examples, aspects of the operations of 1515 may be performed by a scheduling request manager 835 as described with reference to FIG. 8.

At 1520, the method may include receiving a first uplink prescheduling transmission that provides a first uplink grant to the UE. The operations of block 1520 may be performed in accordance with examples as disclosed herein. In some examples, aspects of the operations of 1520 may be performed by an uplink scheduling manager 830 as described with reference to FIG. 8.

At 1525, the method may include transmitting the first uplink transmission using uplink resources provided in the first uplink grant. The operations of block 1525 may be performed in accordance with examples as disclosed herein. In some examples, aspects of the operations of 1525 may be performed by an uplink communication manager 840 as described with reference to FIG. 8.

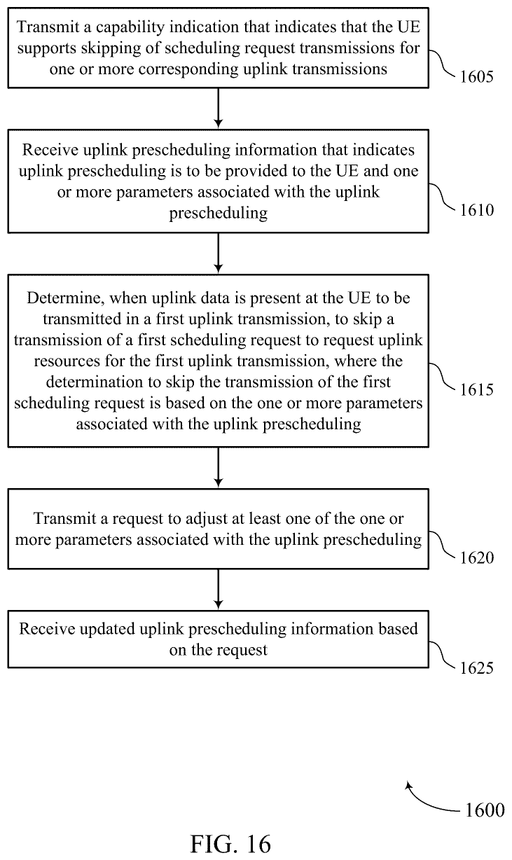

FIG. 16 shows a flowchart illustrating a method 1600 that supports scheduling request techniques in wireless communications in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include transmitting a capability indication that indicates that the UE supports skipping of scheduling request transmissions for one or more corresponding uplink transmissions. The operations of block 1605 may be performed in accordance with examples as disclosed herein. In some examples, aspects of the operations of 1605 may be performed by a capability manager 825 as described with reference to FIG. 8.

At 1610, the method may include receiving uplink prescheduling information that indicates uplink prescheduling is to be provided to the UE and one or more parameters associated with the uplink prescheduling. The operations of block 1610 may be performed in accordance with examples as disclosed herein. In some examples, aspects of the operations of 1610 may be performed by an uplink scheduling manager 830 as described with reference to FIG. 8.

At 1615, the method may include determining, when uplink data is present at the UE to be transmitted in a first uplink transmission, to skip a transmission of a first scheduling request to request uplink resources for the first uplink transmission, where the determination to skip the transmission of the first scheduling request is based on the one or more parameters associated with the uplink prescheduling. The operations of block 1615 may be performed in accordance with examples as disclosed herein. In some examples, aspects of the operations of 1615 may be performed by a scheduling request manager 835 as described with reference to FIG. 8.

At 1620, the method may include transmitting a request to adjust at least one of the one or more parameters associated with the uplink prescheduling. The operations of block 1620 may be performed in accordance with examples as disclosed herein. In some examples, aspects of the operations of 1620 may be performed by an uplink scheduling manager 830 as described with reference to FIG. 8.

At 1625, the method may include receiving updated uplink prescheduling information based on the request. The operations of block 1625 may be performed in accordance with examples as disclosed herein. In some examples, aspects of the operations of 1625 may be performed by an uplink scheduling manager 830 as described with reference to FIG. 8.

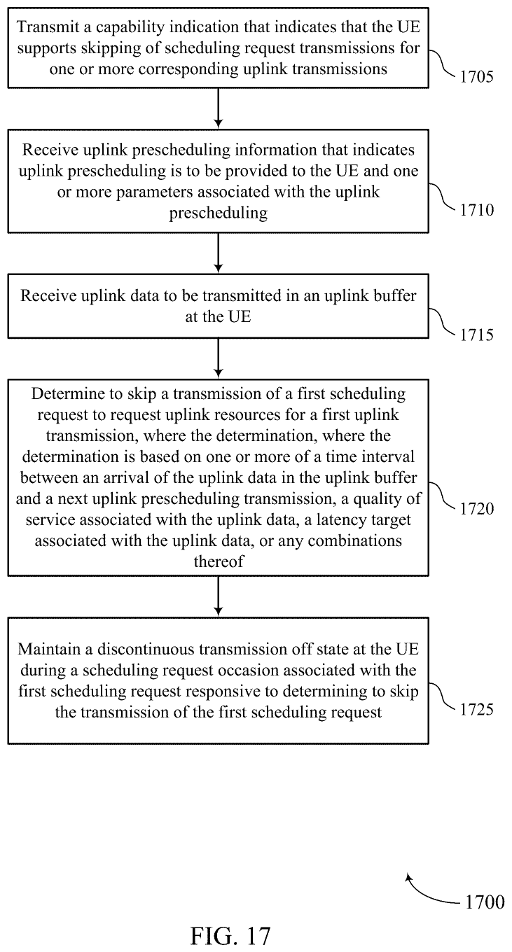

FIG. 17 shows a flowchart illustrating a method 1700 that supports scheduling request techniques in wireless communications in accordance with aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include transmitting a capability indication that indicates that the UE supports skipping of scheduling request transmissions for one or more corresponding uplink transmissions. The operations of block 1705 may be performed in accordance with examples as disclosed herein. In some examples, aspects of the operations of 1705 may be performed by a capability manager 825 as described with reference to FIG. 8.

At 1710, the method may include receiving uplink prescheduling information that indicates uplink prescheduling is to be provided to the UE and one or more parameters associated with the uplink prescheduling. The operations of block 1710 may be performed in accordance with examples as disclosed herein. In some examples, aspects of the operations of 1710 may be performed by an uplink scheduling manager 830 as described with reference to FIG. 8.

At 1715, the method may include receiving uplink data to be transmitted in an uplink buffer at the UE. The operations of block 1715 may be performed in accordance with examples as disclosed herein. In some examples, aspects of the operations of 1715 may be performed by a scheduling request manager 835 as described with reference to FIG. 8.

At 1720, the method may include determining to skip a transmission of a first scheduling request to request uplink resources for a first uplink transmission, where the determination, where the determination is based on one or more of a time interval between an arrival of the uplink data in the uplink buffer and a next uplink prescheduling transmission, a quality of service associated with the uplink data, a latency target associated with the uplink data, or any combinations thereof. The operations of block 1720 may be performed in accordance with examples as disclosed herein. In some examples, aspects of the operations of 1720 may be performed by a scheduling request manager 835 as described with reference to FIG. 8.

At 1725, the method may include maintaining a discontinuous transmission off state at the UE during a scheduling request occasion associated with the first scheduling request responsive to determining to skip the transmission of the first scheduling request. The operations of block 1725 may be performed in accordance with examples as disclosed herein. In some examples, aspects of the operations of 1725 may be performed by a DTX manager 845 as described with reference to FIG. 8.

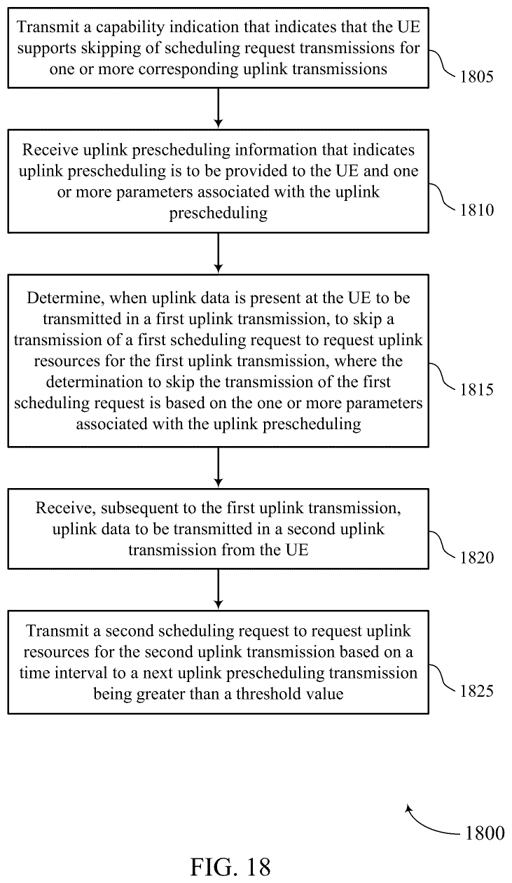

FIG. 18 shows a flowchart illustrating a method 1800 that supports scheduling request techniques in wireless communications in accordance with aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1805, the method may include transmitting a capability indication that indicates that the UE supports skipping of scheduling request transmissions for one or more corresponding uplink transmissions. The operations of block 1805 may be performed in accordance with examples as disclosed herein. In some examples, aspects of the operations of 1805 may be performed by a capability manager 825 as described with reference to FIG. 8.

At 1810, the method may include receiving uplink prescheduling information that indicates uplink prescheduling is to be provided to the UE and one or more parameters associated with the uplink prescheduling. The operations of block 1810 may be performed in accordance with examples as disclosed herein. In some examples, aspects of the operations of 1810 may be performed by an uplink scheduling manager 830 as described with reference to FIG. 8.

At 1815, the method may include determining, when uplink data is present at the UE to be transmitted in a first uplink transmission, to skip a transmission of a first scheduling request to request uplink resources for the first uplink transmission, where the determination to skip the transmission of the first scheduling request is based on the one or more parameters associated with the uplink prescheduling. The operations of block 1815 may be performed in accordance with examples as disclosed herein. In some examples, aspects of the operations of 1815 may be performed by a scheduling request manager 835 as described with reference to FIG. 8.

At 1820, the method may include receiving, subsequent to the first uplink transmission, uplink data to be transmitted in a second uplink transmission from the UE. The operations of block 1820 may be performed in accordance with examples as disclosed herein. In some examples, aspects of the operations of 1820 may be performed by an uplink communication manager 840 as described with reference to FIG. 8.

At 1825, the method may include transmitting a second scheduling request to request uplink resources for the second uplink transmission based on a time interval to a next uplink prescheduling transmission being greater than a threshold value. The operations of block 1825 may be performed in accordance with examples as disclosed herein. In some examples, aspects of the operations of 1825 may be performed by a scheduling request manager 835 as described with reference to FIG. 8.

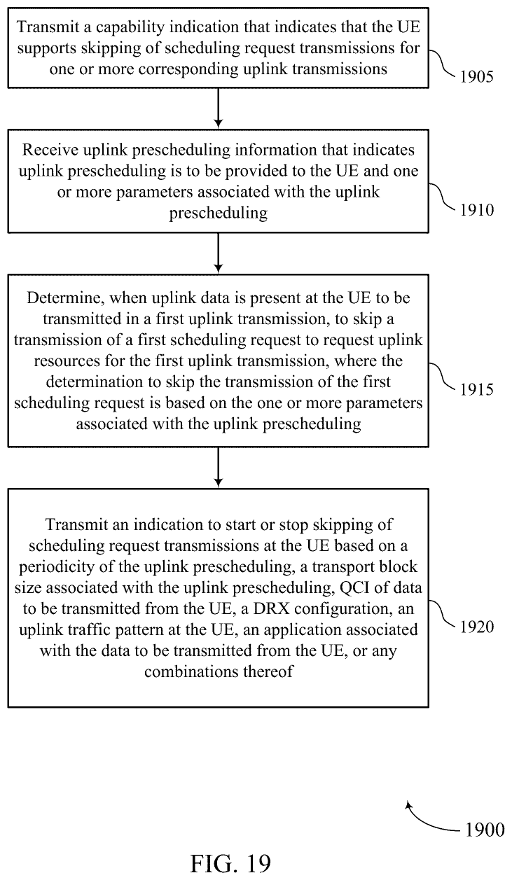

FIG. 19 shows a flowchart illustrating a method 1900 that supports scheduling request techniques in wireless communications in accordance with aspects of the present disclosure. The operations of the method 1900 may be implemented by a UE or its components as described herein. For example, the operations of the method 1900 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1905, the method may include transmitting a capability indication that indicates that the UE supports skipping of scheduling request transmissions for one or more corresponding uplink transmissions. The operations of block 1905 may be performed in accordance with examples as disclosed herein. In some examples, aspects of the operations of 1905 may be performed by a capability manager 825 as described with reference to FIG. 8.

At 1910, the method may include receiving uplink prescheduling information that indicates uplink prescheduling is to be provided to the UE and one or more parameters associated with the uplink prescheduling. The operations of block 1910 may be performed in accordance with examples as disclosed herein. In some examples, aspects of the operations of 1910 may be performed by an uplink scheduling manager 830 as described with reference to FIG. 8.

At 1915, the method may include determining, when uplink data is present at the UE to be transmitted in a first uplink transmission, to skip a transmission of a first scheduling request to request uplink resources for the first uplink transmission, where the determination to skip the transmission of the first scheduling request is based on the one or more parameters associated with the uplink prescheduling. The operations of block 1915 may be performed in accordance with examples as disclosed herein. In some examples, aspects of the operations of 1915 may be performed by a scheduling request manager 835 as described with reference to FIG. 8.

At 1920, the method may include transmitting an indication to start or stop skipping of scheduling request transmissions at the UE based on a periodicity of the uplink prescheduling, a transport block size associated with the uplink prescheduling, QCI of data to be transmitted from the UE, a DRX configuration, an uplink traffic pattern at the UE, an application associated with the data to be transmitted from the UE, or any combinations thereof. The operations of block 1920 may be performed in accordance with examples as disclosed herein. In some examples, aspects of the operations of 1920 may be performed by a scheduling request manager 835 as described with reference to FIG. 8.

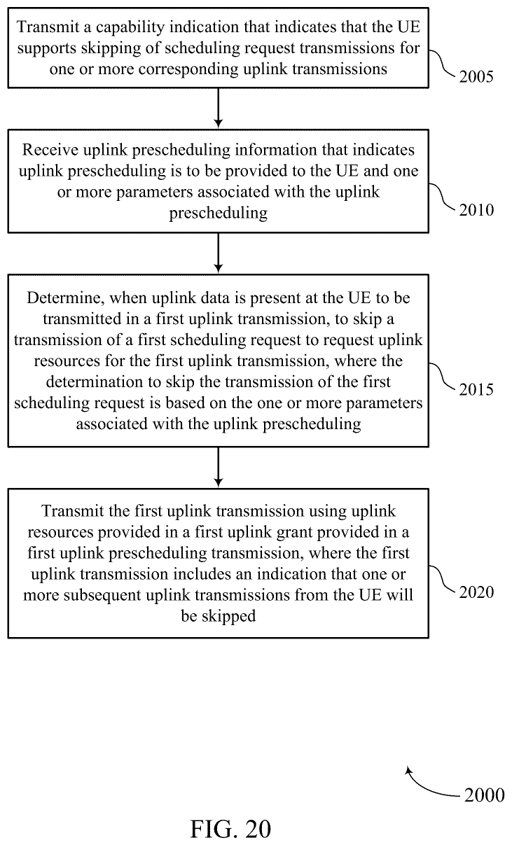

FIG. 20 shows a flowchart illustrating a method 2000 that supports scheduling request techniques in wireless communications in accordance with aspects of the present disclosure. The operations of the method 2000 may be implemented by a UE or its components as described herein. For example, the operations of the method 2000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 2005, the method may include transmitting a capability indication that indicates that the UE supports skipping of scheduling request transmissions for one or more corresponding uplink transmissions. The operations of block 2005 may be performed in accordance with examples as disclosed herein. In some examples, aspects of the operations of 2005 may be performed by a capability manager 825 as described with reference to FIG. 8.

At 2010, the method may include receiving uplink prescheduling information that indicates uplink prescheduling is to be provided to the UE and one or more parameters associated with the uplink prescheduling. The operations of block 2010 may be performed in accordance with examples as disclosed herein. In some examples, aspects of the operations of 2010 may be performed by an uplink scheduling manager 830 as described with reference to FIG. 8.

At 2015, the method may include determining, when uplink data is present at the UE to be transmitted in a first uplink transmission, to skip a transmission of a first scheduling request to request uplink resources for the first uplink transmission, where the determination to skip the transmission of the first scheduling request is based on the one or more parameters associated with the uplink prescheduling. The operations of block 2015 may be performed in accordance with examples as disclosed herein. In some examples, aspects of the operations of 2015 may be performed by a scheduling request manager 835 as described with reference to FIG. 8.

At 2020, the method may include transmitting the first uplink transmission using uplink resources provided in a first uplink grant provided in a first uplink prescheduling transmission, where the first uplink transmission includes an indication that one or more subsequent uplink transmissions from the UE will be skipped. The operations of block 2020 may be performed in accordance with examples as disclosed herein. In some examples, aspects of the operations of 2020 may be performed by an uplink communication manager 840 as described with reference to FIG. 8.

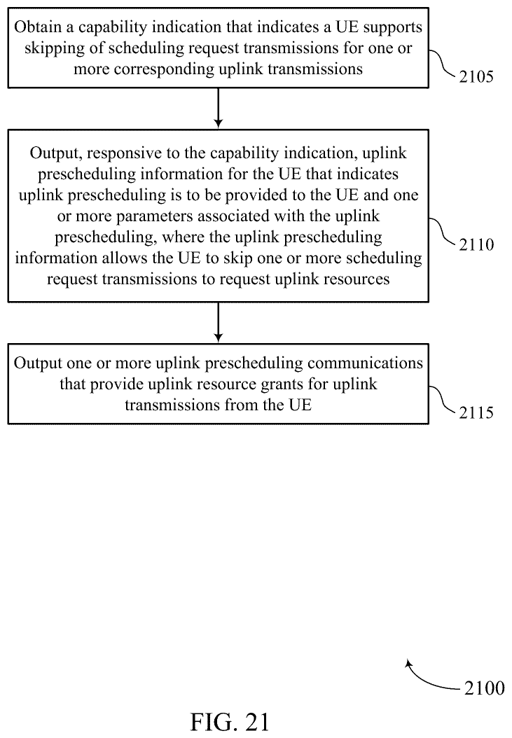

FIG. 21 shows a flowchart illustrating a method 2100 that supports scheduling request techniques in wireless communications in accordance with aspects of the present disclosure. The operations of the method 2100 may be implemented by a network entity or its components as described herein. For example, the operations of the method 2100 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2105, the method may include obtaining a capability indication that indicates a UE supports skipping of scheduling request transmissions for one or more corresponding uplink transmissions. The operations of block 2105 may be performed in accordance with examples as disclosed herein. In some examples, aspects of the operations of 2105 may be performed by a capability manager 1225 as described with reference to FIG. 12.

At 2110, the method may include outputting, responsive to the capability indication, uplink prescheduling information for the UE that indicates uplink prescheduling is to be provided to the UE and one or more parameters associated with the uplink prescheduling, where the uplink prescheduling information allows the UE to skip one or more scheduling request transmissions to request uplink resources. The operations of block 2110 may be performed in accordance with examples as disclosed herein. In some examples, aspects of the operations of 2110 may be performed by a prescheduling manager 1230 as described with reference to FIG. 12.

At 2115, the method may include outputting one or more uplink prescheduling communications that provide uplink resource grants for uplink transmissions from the UE. The operations of block 2115 may be performed in accordance with examples as disclosed herein. In some examples, aspects of the operations of 2115 may be performed by an uplink scheduling manager 1235 as described with reference to FIG. 12.

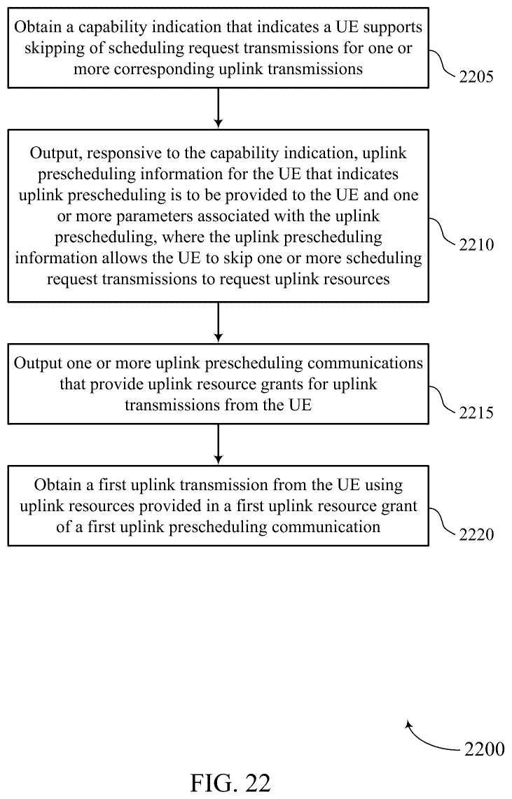

FIG. 22 shows a flowchart illustrating a method 2200 that supports scheduling request techniques in wireless communications in accordance with aspects of the present disclosure. The operations of the method 2200 may be implemented by a network entity or its components as described herein. For example, the operations of the method 2200 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2205, the method may include obtaining a capability indication that indicates a UE supports skipping of scheduling request transmissions for one or more corresponding uplink transmissions. The operations of block 2205 may be performed in accordance with examples as disclosed herein. In some examples, aspects of the operations of 2205 may be performed by a capability manager 1225 as described with reference to FIG. 12.

At 2210, the method may include outputting, responsive to the capability indication, uplink prescheduling information for the UE that indicates uplink prescheduling is to be provided to the UE and one or more parameters associated with the uplink prescheduling, where the uplink prescheduling information allows the UE to skip one or more scheduling request transmissions to request uplink resources. The operations of block 2210 may be performed in accordance with examples as disclosed herein. In some examples, aspects of the operations of 2210 may be performed by a prescheduling manager 1230 as described with reference to FIG. 12.

At 2215, the method may include outputting one or more uplink prescheduling communications that provide uplink resource grants for uplink transmissions from the UE. The operations of block 2215 may be performed in accordance with examples as disclosed herein. In some examples, aspects of the operations of 2215 may be performed by an uplink scheduling manager 1235 as described with reference to FIG. 12.

At 2220, the method may include obtaining a first uplink transmission from the UE using uplink resources provided in a first uplink resource grant of a first uplink prescheduling communication. The operations of block 2220 may be performed in accordance with examples as disclosed herein. In some examples, aspects of the operations of 2220 may be performed by an uplink communication manager 1240 as described with reference to FIG. 12.

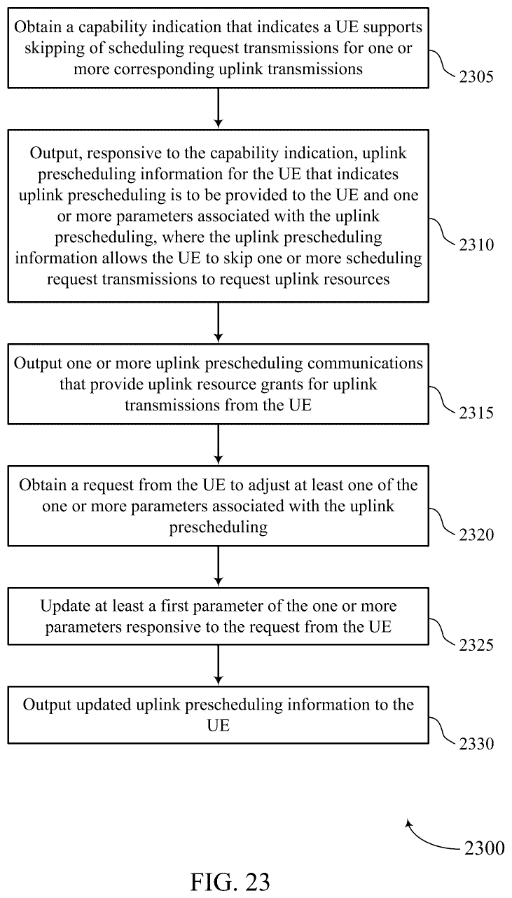

FIG. 23 shows a flowchart illustrating a method 2300 that supports scheduling request techniques in wireless communications in accordance with aspects of the present disclosure. The operations of the method 2300 may be implemented by a network entity or its components as described herein. For example, the operations of the method 2300 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2305, the method may include obtaining a capability indication that indicates a UE supports skipping of scheduling request transmissions for one or more corresponding uplink transmissions. The operations of block 2305 may be performed in accordance with examples as disclosed herein. In some examples, aspects of the operations of 2305 may be performed by a capability manager 1225 as described with reference to FIG. 12.

At 2310, the method may include outputting, responsive to the capability indication, uplink prescheduling information for the UE that indicates uplink prescheduling is to be provided to the UE and one or more parameters associated with the uplink prescheduling, where the uplink prescheduling information allows the UE to skip one or more scheduling request transmissions to request uplink resources. The operations of block 2310 may be performed in accordance with examples as disclosed herein. In some examples, aspects of the operations of 2310 may be performed by a prescheduling manager 1230 as described with reference to FIG. 12.

At 2315, the method may include outputting one or more uplink prescheduling communications that provide uplink resource grants for uplink transmissions from the UE. The operations of block 2315 may be performed in accordance with examples as disclosed herein. In some examples, aspects of the operations of 2315 may be performed by an uplink scheduling manager 1235 as described with reference to FIG. 12.

At 2320, the method may include obtaining a request from the UE to adjust at least one of the one or more parameters associated with the uplink prescheduling. The operations of block 2320 may be performed in accordance with examples as disclosed herein. In some examples, aspects of the operations of 2320 may be performed by a prescheduling manager 1230 as described with reference to FIG. 12.

At 2325, the method may include updating at least a first parameter of the one or more parameters responsive to the request from the UE. The operations of block 2325 may be performed in accordance with examples as disclosed herein. In some examples, aspects of the operations of 2325 may be performed by a prescheduling manager 1230 as described with reference to FIG. 12.

At 2330, the method may include outputting updated uplink prescheduling information to the UE. The operations of block 2330 may be performed in accordance with examples as disclosed herein. In some examples, aspects of the operations of 2330 may be performed by a prescheduling manager 1230 as described with reference to FIG. 12.

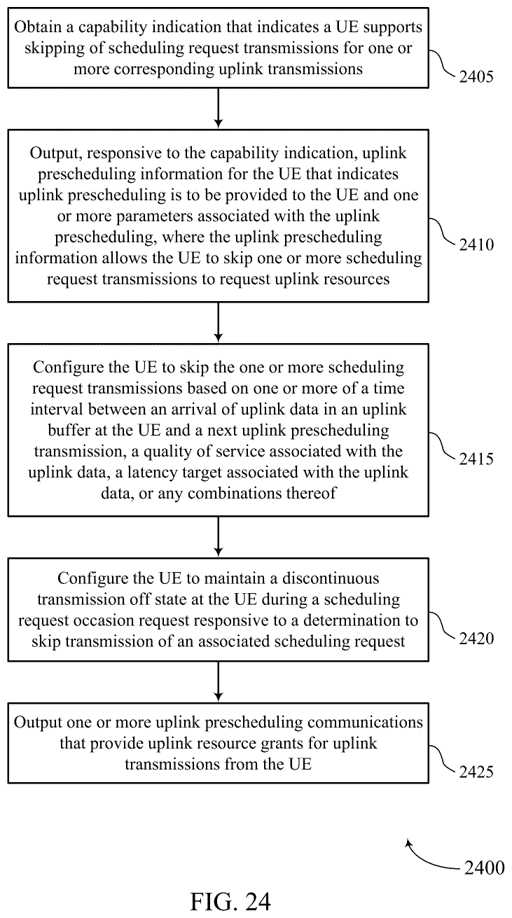

FIG. 24 shows a flowchart illustrating a method 2400 that supports scheduling request techniques in wireless communications in accordance with aspects of the present disclosure. The operations of the method 2400 may be implemented by a network entity or its components as described herein. For example, the operations of the method 2400 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2405, the method may include obtaining a capability indication that indicates a UE supports skipping of scheduling request transmissions for one or more corresponding uplink transmissions. The operations of block 2405 may be performed in accordance with examples as disclosed herein. In some examples, aspects of the operations of 2405 may be performed by a capability manager 1225 as described with reference to FIG. 12.

At 2410, the method may include outputting, responsive to the capability indication, uplink prescheduling information for the UE that indicates uplink prescheduling is to be provided to the UE and one or more parameters associated with the uplink prescheduling, where the uplink prescheduling information allows the UE to skip one or more scheduling request transmissions to request uplink resources. The operations of block 2410 may be performed in accordance with examples as disclosed herein. In some examples, aspects of the operations of 2410 may be performed by a prescheduling manager 1230 as described with reference to FIG. 12.

At 2415, the method may include configuring the UE to skip the one or more scheduling request transmissions based on one or more of a time interval between an arrival of uplink data in an uplink buffer at the UE and a next uplink prescheduling transmission, a quality of service associated with the uplink data, a latency target associated with the uplink data, or any combinations thereof. The operations of block 2415 may be performed in accordance with examples as disclosed herein. In some examples, aspects of the operations of 2415 may be performed by a scheduling request manager 1245 as described with reference to FIG. 12.

At 2420, the method may include configuring the UE to maintain a discontinuous transmission off state at the UE during a scheduling request occasion request responsive to a determination to skip transmission of an associated scheduling request. The operations of block 2420 may be performed in accordance with examples as disclosed herein. In some examples, aspects of the operations of 2420 may be performed by a DTX manager 1250 as described with reference to FIG. 12.

At 2425, the method may include outputting one or more uplink prescheduling communications that provide uplink resource grants for uplink transmissions from the UE. The operations of block 2425 may be performed in accordance with examples as disclosed herein. In some examples, aspects of the operations of 2425 may be performed by an uplink scheduling manager 1235 as described with reference to FIG. 12.

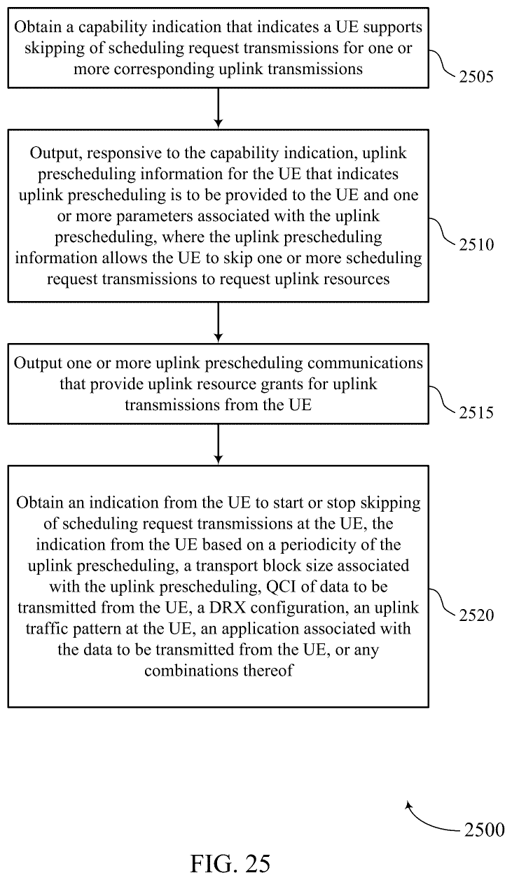

FIG. 25 shows a flowchart illustrating a method 2500 that supports scheduling request techniques in wireless communications in accordance with aspects of the present disclosure. The operations of the method 2500 may be implemented by a network entity or its components as described herein. For example, the operations of the method 2500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2505, the method may include obtaining a capability indication that indicates a UE supports skipping of scheduling request transmissions for one or more corresponding uplink transmissions. The operations of block 2505 may be performed in accordance with examples as disclosed herein. In some examples, aspects of the operations of 2505 may be performed by a capability manager 1225 as described with reference to FIG. 12.

At 2510, the method may include outputting, responsive to the capability indication, uplink prescheduling information for the UE that indicates uplink prescheduling is to be provided to the UE and one or more parameters associated with the uplink prescheduling, where the uplink prescheduling information allows the UE to skip one or more scheduling request transmissions to request uplink resources. The operations of block 2510 may be performed in accordance with examples as disclosed herein. In some examples, aspects of the operations of 2510 may be performed by a prescheduling manager 1230 as described with reference to FIG. 12.

At 2515, the method may include outputting one or more uplink prescheduling communications that provide uplink resource grants for uplink transmissions from the UE. The operations of block 2515 may be performed in accordance with examples as disclosed herein. In some examples, aspects of the operations of 2515 may be performed by an uplink scheduling manager 1235 as described with reference to FIG. 12.

At 2520, the method may include obtaining an indication from the UE to start or stop skipping of scheduling request transmissions at the UE, the indication from the UE based on a periodicity of the uplink prescheduling, a transport block size associated with the uplink prescheduling, QCI of data to be transmitted from the UE, a DRX configuration, an uplink traffic pattern at the UE, an application associated with the data to be transmitted from the UE, or any combinations thereof. The operations of block 2520 may be performed in accordance with examples as disclosed herein. In some examples, aspects of the operations of 2520 may be performed by a prescheduling manager 1230 as described with reference to FIG. 12.

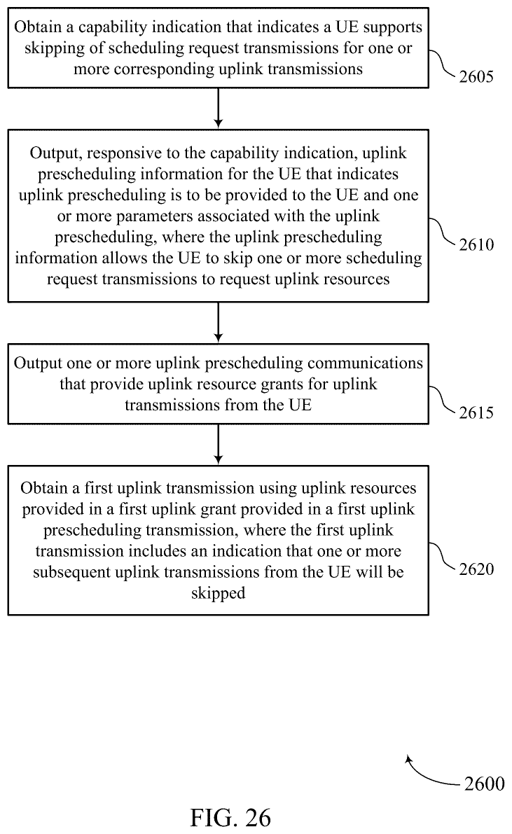

FIG. 26 shows a flowchart illustrating a method 2600 that supports scheduling request techniques in wireless communications in accordance with aspects of the present disclosure. The operations of the method 2600 may be implemented by a network entity or its components as described herein. For example, the operations of the method 2600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2605, the method may include obtaining a capability indication that indicates a UE supports skipping of scheduling request transmissions for one or more corresponding uplink transmissions. The operations of block 2605 may be performed in accordance with examples as disclosed herein. In some examples, aspects of the operations of 2605 may be performed by a capability manager 1225 as described with reference to FIG. 12.

At 2610, the method may include outputting, responsive to the capability indication, uplink prescheduling information for the UE that indicates uplink prescheduling is to be provided to the UE and one or more parameters associated with the uplink prescheduling, where the uplink prescheduling information allows the UE to skip one or more scheduling request transmissions to request uplink resources. The operations of block 2610 may be performed in accordance with examples as disclosed herein. In some examples, aspects of the operations of 2610 may be performed by a prescheduling manager 1230 as described with reference to FIG. 12.

At 2615, the method may include outputting one or more uplink prescheduling communications that provide uplink resource grants for uplink transmissions from the UE. The operations of block 2615 may be performed in accordance with examples as disclosed herein. In some examples, aspects of the operations of 2615 may be performed by an uplink scheduling manager 1235 as described with reference to FIG. 12.

At 2620, the method may include obtaining a first uplink transmission using uplink resources provided in a first uplink grant provided in a first uplink prescheduling transmission, where the first uplink transmission includes an indication that one or more subsequent uplink transmissions from the UE will be skipped. The operations of block 2620 may be performed in accordance with examples as disclosed herein. In some examples, aspects of the operations of 2620 may be performed by an uplink communication manager 1240 as described with reference to FIG. 12.

The following provides an overview of aspects of the present disclosure:

Aspect 1: A method for wireless communications at a UE, comprising: transmitting a capability indication that indicates that the UE supports skipping of scheduling request transmissions for one or more corresponding uplink transmissions; receiving uplink prescheduling information that indicates uplink prescheduling is to be provided to the UE and one or more parameters associated with the uplink prescheduling; and determining, when uplink data is present at the UE to be transmitted in a first uplink transmission, to skip a transmission of a first scheduling request to request uplink resources for the first uplink transmission, wherein the determination to skip the transmission of the first scheduling request is based at least in part on the one or more parameters associated with the uplink prescheduling.

Aspect 2: The method of aspect 1, further comprising: receiving a first uplink prescheduling transmission that provides a first uplink grant to the UE; and transmitting the first uplink transmission using uplink resources provided in the first uplink grant.

Aspect 3: The method of any of aspects 1 through 2, further comprising: transmitting a request to adjust at least one of the one or more parameters associated with the uplink prescheduling.

Aspect 4: The method of aspect 3, further comprising: receiving updated uplink prescheduling information based at least in part on the request.

Aspect 5: The method of any of aspects 3 through 4, wherein the request is transmitted subsequent to one or more uplink transmissions that use uplink resources indicated in one or more corresponding uplink prescheduling transmissions.

Aspect 6: The method of any of aspects 3 through 5, wherein the request to adjust at least one of the one or more parameters associated with the uplink prescheduling is based at least in part on one or more quality of service targets associated with uplink data that is to be transmitted from the UE.

Aspect 7: The method of any of aspects 1 through 6, wherein the one or more parameters associated with the uplink prescheduling include one or more of a type of uplink data to be transmitted, a trigger condition for initiating the uplink prescheduling, a time interval over which the uplink prescheduling will be provided, a periodicity of associated uplink transmissions, a duration of the uplink prescheduling, a transport block size of uplink grants to be provided by the uplink prescheduling, or any combinations thereof.

Aspect 8: The method of any of aspects 1 through 7, further comprising: receiving uplink data to be transmitted in an uplink buffer at the UE, and wherein the determining is further based at least in part on one or more of a time interval between an arrival of the uplink data in the uplink buffer and a next uplink prescheduling transmission, a quality of service associated with the uplink data, a latency target associated with the uplink data, or any combinations thereof.

Aspect 9: The method of aspect 8, further comprising: maintaining a discontinuous transmission off state at the UE during a scheduling request occasion associated with the first scheduling request responsive to determining to skip the transmission of the first scheduling request.

Aspect 10: The method of any of aspects 1 through 9, further comprising: receiving, subsequent to the first uplink transmission, uplink data to be transmitted in a second uplink transmission from the UE; and transmitting a second scheduling request to request uplink resources for the second uplink transmission based at least in part on a time interval to a next uplink prescheduling transmission being greater than a threshold value.

Aspect 11: The method of any of aspects 1 through 10, further comprising: transmitting an indication to start or stop skipping of scheduling request transmissions at the UE based at least in part on a periodicity of the uplink prescheduling, a transport block size associated with the uplink prescheduling, QCI of data to be transmitted from the UE, a DRX configuration, an uplink traffic pattern at the UE, an application associated with the data to be transmitted from the UE, or any combinations thereof.

Aspect 12: The method of any of aspects 1 through 11, further comprising: transmitting the first uplink transmission using uplink resources provided in a first uplink grant provided in a first uplink prescheduling transmission, wherein the first uplink transmission includes an indication that one or more subsequent uplink transmissions from the UE will be skipped.

Aspect 13: The method of aspect 12, wherein the indication that one or more subsequent uplink transmissions from the UE will be skipped is provided in a MAC-CE that indicates one or more of a quantity of skipped uplink transmissions, a cause for skipped uplink transmissions, or any combinations thereof.

Aspect 14: The method of aspect 12, wherein the indication that one or more subsequent uplink transmissions from the UE will be skipped is based at least in part on a transport block size associated with the first uplink grant, an uplink traffic predication or expected data flow for uplink traffic, or any combination thereof.

Aspect 14: A method for wireless communications at a network entity, comprising: obtaining a capability indication that indicates a UE supports skipping of scheduling request transmissions for one or more corresponding uplink transmissions; outputting, responsive to the capability indication, uplink prescheduling information for the UE that indicates uplink prescheduling is to be provided to the UE and one or more parameters associated with the uplink prescheduling, wherein the uplink prescheduling information allows the UE to skip one or more scheduling request transmissions to request uplink resources; and outputting one or more uplink prescheduling communications that provide uplink resource grants for uplink transmissions from the UE.

Aspect 15: The method of aspect 14, further comprising: obtaining a first uplink transmission from the UE using uplink resources provided in a first uplink resource grant of a first uplink prescheduling communication.

Aspect 16: The method of any of aspects 14 through 15, further comprising: obtaining a request from the UE to adjust at least one of the one or more parameters associated with the uplink prescheduling.

Aspect 17: The method of aspect 16, further comprising: updating at least a first parameter of the one or more parameters responsive to the request from the UE; and outputting updated uplink prescheduling information to the UE.

Aspect 18: The method of any of aspects 16 through 17, wherein the request is provided subsequent to one or more uplink transmissions that use uplink resources indicated in one or more corresponding uplink prescheduling transmissions.

Aspect 19: The method of any of aspects 16 through 18, wherein the request to adjust at least one of the one or more parameters associated with the uplink prescheduling is based at least in part on one or more quality of service targets associated with uplink data that is to be transmitted from the UE.

Aspect 20: The method of any of aspects 14 through 19, wherein the one or more parameters associated with the uplink prescheduling include one or more of a type of uplink data to be transmitted, a trigger condition for initiating the uplink prescheduling, a time interval over which the uplink prescheduling will be provided, a periodicity of associated uplink transmissions, a duration of the uplink prescheduling, a transport block size of uplink grants to be provided by the uplink prescheduling, or any combinations thereof.

Aspect 21: The method of any of aspects 14 through 20, further comprising: configuring the UE to skip the one or more scheduling request transmissions based at least in part on one or more of a time interval between an arrival of uplink data in an uplink buffer at the UE and a next uplink prescheduling transmission, a quality of service associated with the uplink data, a latency target associated with the uplink data, or any combinations thereof.

Aspect 22: The method of aspect 21, further comprising: configuring the UE to maintain a discontinuous transmission off state at the UE during a scheduling request occasion request responsive to a determination to skip transmission of an associated scheduling request.

Aspect 23: The method of any of aspects 14 through 22, further comprising: obtaining an indication from the UE to start or stop skipping of scheduling request transmissions at the UE, the indication from the UE based at least in part on a periodicity of the uplink prescheduling, a transport block size associated with the uplink prescheduling, QCI of data to be transmitted from the UE, a DRX configuration, an uplink traffic pattern at the UE, an application associated with the data to be transmitted from the UE, or any combinations thereof.

Aspect 24: The method of any of aspects 14 through 23, further comprising: obtaining a first uplink transmission using uplink resources provided in a first uplink grant provided in a first uplink prescheduling transmission, wherein the first uplink transmission includes an indication that one or more subsequent uplink transmissions from the UE will be skipped.

Aspect 25: The method of aspect 24, wherein the indication that one or more subsequent uplink transmissions from the UE will be skipped is provided in a MAC-CE that indicates one or more of a quantity of skipped uplink transmissions, a cause for skipped uplink transmissions, or any combinations thereof.

Aspect 26: A UE for wireless communications, comprising one or more memories storing processor-executable code, and one or more processors coupled with the one or more memories and individually or collectively operable to execute the code to cause the UE to perform a method of any of aspects 1 through 13.

Aspect 27: A UE for wireless communications, comprising at least one means for performing a method of any of aspects 1 through 13.

Aspect 28: A non-transitory computer-readable medium storing code for wireless communications, the code comprising instructions executable by one or more processors to perform a method of any of aspects 1 through 13.

Aspect 29: A network entity for wireless communications, comprising one or more memories storing processor-executable code, and one or more processors coupled with the one or more memories and individually or collectively operable to execute the code to cause the network entity to perform a method of any of aspects 14 through 25.

Aspect 30: A network entity for wireless communications, comprising at least one means for performing a method of any of aspects 14 through 25.

Aspect 31: A non-transitory computer-readable medium storing code for wireless communications, the code comprising instructions executable by one or more processors to perform a method of any of aspects 14 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a capability indication that indicates that the UE supports skipping of scheduling request transmissions for one or more corresponding uplink transmissions;
receive uplink prescheduling information that indicates uplink prescheduling is to be provided to the UE and one or more parameters associated with the uplink prescheduling; and
determine, when uplink data is present at the UE to be transmitted in a first uplink transmission, to skip a transmission of a first scheduling request to request uplink resources for the first uplink transmission, wherein the determination to skip the transmission of the first scheduling request is based at least in part on the one or more parameters associated with the uplink prescheduling.

2. The UE of claim 1, wherein the one or more processors are individually or collectively further operable to execute the code to cause the UE to:
receive a first uplink prescheduling transmission that provides a first uplink grant to the UE; and
transmit the first uplink transmission using uplink resources provided in the first uplink grant.

3. The UE of claim 1, wherein the one or more processors are individually or collectively further operable to execute the code to cause the UE to:
transmit a request to adjust at least one of the one or more parameters associated with the uplink prescheduling.

4. The UE of claim 3, wherein the one or more processors are individually or collectively further operable to execute the code to cause the UE to:
receive updated uplink prescheduling information based at least in part on the request.

5. The UE of claim 3, wherein:
the request is transmitted subsequent to one or more uplink transmissions that use uplink resources indicated in one or more corresponding uplink prescheduling transmissions.

6. The UE of claim 3, wherein the request to adjust at least one of the one or more parameters associated with the uplink prescheduling is based at least in part on one or more quality of service targets associated with uplink data that is to be transmitted from the UE.

7. The UE of claim 1, wherein the one or more parameters associated with the uplink prescheduling include one or more of a type of uplink data to be transmitted, a trigger condition for initiating the uplink prescheduling, a time interval over which the uplink prescheduling will be provided, a periodicity of associated uplink transmissions, a duration of the uplink prescheduling, a transport block size of uplink grants to be provided by the uplink prescheduling, or any combinations thereof.

8. The UE of claim 1, wherein the one or more processors are individually or collectively further operable to execute the code to cause the UE to:
receive uplink data to be transmitted in an uplink buffer at the UE, and wherein the determination to skip the transmission of the first scheduling request is further based at least in part on one or more of a time interval between an arrival of the uplink data in the uplink buffer and a next uplink prescheduling transmission, a quality of service associated with the uplink data, a latency target associated with the uplink data, or any combinations thereof.

9. The UE of claim 8, wherein the one or more processors are individually or collectively further operable to execute the code to cause the UE to:
maintain a discontinuous transmission off state at the UE during a scheduling request occasion associated with the first scheduling request responsive to the determination to skip the transmission of the first scheduling request.

10. The UE of claim 1, wherein the one or more processors are individually or collectively further operable to execute the code to cause the UE to:
receive, subsequent to the first uplink transmission, uplink data to be transmitted in a second uplink transmission from the UE; and
transmit a second scheduling request to request uplink resources for the second uplink transmission based at least in part on a time interval to a next uplink prescheduling transmission being greater than a threshold value.

11. The UE of claim 1, wherein the one or more processors are individually or collectively further operable to execute the code to cause the UE to:
transmit an indication to start or stop skipping of scheduling request transmissions at the UE based at least in part on a periodicity of the uplink prescheduling, a transport block size associated with the uplink prescheduling, quality of service class identifier (QCI) of data to be transmitted from the UE, a discontinuous reception (DRX) configuration, an uplink traffic pattern at the UE, an application associated with the data to be transmitted from the UE, or any combinations thereof.

12. The UE of claim 1, wherein the one or more processors are individually or collectively further operable to execute the code to cause the UE to:
transmit the first uplink transmission using uplink resources provided in a first uplink grant provided in a first uplink prescheduling transmission, wherein the first uplink transmission includes an indication that one or more subsequent uplink transmissions from the UE will be skipped.

13. The UE of claim 12, wherein the indication that one or more subsequent uplink transmissions from the UE will be skipped is provided in a medium access control (MAC) control element that indicates one or more of a quantity of skipped uplink transmissions, a cause for skipped uplink transmissions, or any combinations thereof.

14. The UE of claim 12, wherein the indication that one or more subsequent uplink transmissions from the UE will be skipped is based at least in part on a transport block size associated with the first uplink grant, an expected data flow for uplink traffic, or any combination thereof.

15. A method for wireless communications at a user equipment (UE), comprising:
transmitting a capability indication that indicates that the UE supports skipping of scheduling request transmissions for one or more corresponding uplink transmissions;
receiving uplink prescheduling information that indicates uplink prescheduling is to be provided to the UE and one or more parameters associated with the uplink prescheduling; and
determining, when uplink data is present at the UE to be transmitted in a first uplink transmission, to skip a transmission of a first scheduling request to request uplink resources for the first uplink transmission, wherein the determination to skip the transmission of the first scheduling request is based at least in part on the one or more parameters associated with the uplink prescheduling.

16. The method of claim 15, further comprising:
receiving a first uplink prescheduling transmission that provides a first uplink grant to the UE; and
transmitting the first uplink transmission using uplink resources provided in the first uplink grant.

17. The method of claim 15, further comprising:
transmitting a request to adjust at least one of the one or more parameters associated with the uplink prescheduling; and
receiving updated uplink prescheduling information based at least in part on the request.

18. The method of claim 15, wherein the one or more parameters associated with the uplink prescheduling include one or more of a type of uplink data to be transmitted, a trigger condition for initiating the uplink prescheduling, a time interval over which the uplink prescheduling will be provided, a periodicity of associated uplink transmissions, a duration of the uplink prescheduling, a transport block size of uplink grants to be provided by the uplink prescheduling, or any combinations thereof.

19. A non-transitory computer-readable medium storing code for wireless communications, the code comprising instructions executable by one or more processors to:
transmit, from a user equipment (UE), a capability indication that indicates that the UE supports skipping of scheduling request transmissions for one or more corresponding uplink transmissions;
receive uplink prescheduling information that indicates uplink prescheduling is to be provided to the UE and one or more parameters associated with the uplink prescheduling; and
determine, when uplink data is present at the UE to be transmitted in a first uplink transmission, to skip a transmission of a first scheduling request to request uplink resources for the first uplink transmission, wherein the determination to skip the transmission of the first scheduling request is based at least in part on the one or more parameters associated with the uplink prescheduling.

20. The non-transitory computer-readable medium of claim 19, wherein the instructions are further executable by the one or more processors to:
receive a first uplink prescheduling transmission that provides a first uplink grant to the UE; and
transmit the first uplink transmission using uplink resources provided in the first uplink grant.
